(19) United States
(12) Patent Application Publication
(10) Pub. No.: US 2026/0218336 A1
(43) Pub. Date: Jul. 30, 2026

(54) A NICKEL-BASED ALLOY

(71) Applicant: ALLOYED LIMITED, Yarnton Kidlington Oxfordshire (GB)

(72) Inventors: David CRUDDEN, Yarnton Kidlington Oxfordshire (GB); John William Gordon CLARK, Yarnton Kidlington Oxfordshire (GB); Andre NEMETH, Yarnton Kidlington Oxfordshire (GB); Yining HE, Yarnton Kidlington Oxfordshire (GB)

(21) Appl. No.: 19/149,197

(22) PCT Filed: Jan. 12, 2024
(86) PCT No.: PCT/GB2024/050073

§ 371 Date: Jul. 18, 2025

(30) Foreign Application Priority Data
Jan. 20, 2023 (GB) 2300903.8

(51) Int. Cl. C22C 1/04; B33Y 70/10; C22C 19/05

(52) U.S. Cl. CPC C22C 1/0433; B33Y 70/10; C22C 19/056

(57) ABSTRACT

A nickel-based alloy composition consisting, in weight percent, of: 1.5 to 4.5% aluminium. 1.1 to 3.4% titanium, 0.0 to 4.0% niobium, 0.0 to 5.2% tantalum, 0.9 to 6.6% tungsten, 0.0 to 3.0% molybdenum, 0.0 to 24.0% cobalt, 12.5 to 20.6% chromium, 0.02 to 0.15% carbon, 0.001 to 0.015% boron, 0.0 to 0.1% zirconium, 0.0 to 3.0% rhenium, 0.0 to 2.0% ruthenium, 0.0 to 3.0% iridium, 0.0 to 0.5% vanadium, 0.0 to 1.0% palladium, 0.0 to 1.0% platinum, 0.0 to 0.5% silicon, 0.0 to 0.1% yttrium, 0.0 to 0.1% lanthanum, 0.0 to 0.1% cerium, 0.0 to 0.003% sulphur, 0.0 to 0.25% manganese, 0.0 to 0.1 magnesium, 0.0 to 5.0% iron, 0.0 to 0.5% copper, 0.0 to 1.0% hafnium, the balance being nickel and incidental impurities, wherein the following equations are satisfied in which W_{Al}, W_{Ti}, W_{Nb}, W_{Ta} and W_{W} are the weight percent of aluminium, titanium, niobium, tantalum and tungsten in the alloy respectively 0.65≤0.3 W_{Nb}+0.15 W 3.6≤W_{Al}+0.5 W_{Ti}+0.3 W_{Nb}+0.15 W_{Ta}≤5.7 W_{Ta}+0.92 W_{W}≤6.1.

### FIELD OF THE INVENTION

The present invention relates to a nickel-based superalloy composition designed for application in additive manufacturing (AM) processes, examples of such processes including but not limited to, powder-bed based AM methods (e.g. selective laser melting, electron beam melting), direct metal deposition methods (e.g. powder deposition and wire based methods).

### BACKGROUND ART

Currently, there has been a tendency to migrate nickel-based superalloys which have been successfully manufactured in cast form or wrought form to the AM process. However, this has proven largely inappropriate because many of the material characteristic required for ease of processing in the AM process are not fulfilled by such alloys leading to substantial difficulties in processing and resulting in materials which do not have the expected structural integrity.

In particular there has been significant challenge to develop high volume fraction of γ′ alloys for the additive manufacturing process, as these alloys are often classed as ‘non-weldable’. Commonly these alloys are processed by investment casting method, examples of common alloys used for the investment casting process are listed in Table 1.

The application of the alloys listed in Table 1 for additive manufacturing (AM) methods has been widely studied. Two of the most significant limitations of these alloys when used for AM processing are, (i) high temperature creep resistance is lower than the equivalent cast material and (ii) cracking during AM processing through ‘strain age cracking’ hot cracking’ occurring.

It is desirable to develop a high volume fraction of γ′ alloy which overcomes the limitations of alloys in Table 1 by tailoring alloy chemistry.

TABLE 1
Nominal composition in wt. % of conventional high volume fraction of γ′ alloys.

| Alloy (wt. %) | Al | Co | Cr | Mo | Nb | Ta | Ti | W | C | B | Zr | Hf |
|---|---|---|---|---|---|---|---|---|---|---|---|---|
| IN738 | 3.4 | 8.5 | 16.0 | 1.8 | 0.9 | 1.8 | 3.4 | 2.6 | 0.11 | 0.01 | 0.04 | 0 |
| CM247 | 5.5 | 9.5 | 8.4 | 0.5 | 0.0 | 3.0 | 0.7 | 9.5 | 0.07 | 0.015 | 0.015 | 1.5 |
| IN713 | 6.0 | 0.0 | 12.5 | 4.5 | 2.0 | 0.0 | 0.8 | 0.0 | 0.12 | 0.001 | 0.10 | 0 |
| IN792 | 3.2 | 9.0 | 12.7 | 1.8 | 0.0 | 3.9 | 4.2 | 3.9 | 0.07 | 0.016 | 0.018 | 0 |

### SUMMARY OF THE INVENTION

A solution to at least one or more of the aforementioned problems with AM alloys has been discovered. In one aspect, the solution can include an AM alloy that has improved creep and/or strain age cracking resistance. The AM alloy of the invention can preferably have a desirable level of tensile strength, freezing range, and hot cracking resistance combined with acceptable oxidation resistance and/or microstructural stability.

The present invention provides a nickel-based alloy composition consisting, in weight percent, of: 4.0 to 6.0% (e.g., 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, or 6.0%, or any range or number therein) aluminium, 1.1 to 6.0% (e.g., 1.1, 1.2, 1.3, 1.4, 1.5, 1.6, 1.7, 1.8, 1.9, 2.0, 2.5, 3.0, 3.5, 4.0, 4.5, 5.0, 5.5, or 6.0%, or any range or number therein) titanium, 0.0 to 4.0% (e.g., 0.0, 0.1, 0.2, 0.3, 0.4, 0.5, 0.6, 0.7, 0.8, 0.9, 1.0, 1.5, 2.0, 2.5, 3.0, 3.5, or 4.0%, or any range or number therein) niobium, 0.0 to 11.9% (e.g., 0.0, 0.5, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, 10.0, 10.5, 11.0, 11.1, 11.2, 11.3, 11.4, 11.5, 11.6, 11.7, 11.8, or 11.9%, or any range or number therein) tantalum, 2.0 to 12.7% (e.g., 2.0, 2.5, 3.0, 3.5, 4.0, 4.5, 5.0, 5.5, 6.0, 6.5, 7.0, 7.5, 8.0, 8.5, 9.0, 9.5, 10.0, 10.5, 11.0, 11.5, 12.0, 12.1, 12.2, 12.3, 12.4, 12.5, 12.6, or 12.7%, or any range or number therein) tungsten, 0.0 to 3.0% (e.g., 0.1, 0.2, 0.3, 0.4, 0.5, 0.6, 0.7, 0.8, 0.9, 1.0, 1.5, 2.0, 2.5, or 3.0%, or any range or number therein) molybdenum, 0.0 to 22.0% (e.g., 0.1, 0.2, 0.3, 0.4, 0.5, 0.6, 0.7, 0.8, 0.9, 1.0, 2.0, 3.0, 4.0, 5.0, 6.0, 7.0, 8.0, 9.0, 10.0, 11.0, 12.0, 13.0, 14.0, 15.0, 16.0, 17.0, 18.0, 19.0, 20.0, 21.0, or 22.0%, or any range or number therein) cobalt, 6.0 to 16.7% (e.g., 6.0, 7.0, 8.0, 9.0, 10.0, 11.0, 12.0, 13.0, 14.0, 15.0, 16.0, 16.1, 16.2, 16.3, 16.4, 16.5, 16.6, or 16.7%, or any range or number therein) chromium, 0.02 to 0.35% (e.g., 0.02, 0.03, 0.04, 0.05, 0.06, 0.07, 0.08, 0.09, 0.10, 0.20, 0.30, 0.31, 0.32, 0.33, 0.34, or 0.35%, or any range or number therein) carbon, 0.001 to 0.2% (e.g., 0.001, 0.002, 0.003, 0.004, 0.005, 0.006, 0.007, 0.008, 0.009, 0.01, 0.1, or 0.2%, or any range or number therein) boron, 0.00 to 0.01% zirconium, 0.0 to 3.0% (e.g., 0.0, 0.1, 0.2, 0.3, 0.4, 0.5, 0.6, 0.7, 0.8, 0.9, 1.0, 2.0, or 3.0%, or any range or number therein) rhenium, 0.0 to 3.0% (e.g., 0.0, 0.1, 0.2, 0.3, 0.4, 0.5, 0.6, 0.7, 0.8, 0.9, 1.0, 2.0, or 3.0%, or any range or number therein) ruthenium, 0.0 to 3.0% (e.g., 0.0, 0.1, 0.2, 0.3, 0.4, 0.5, 0.6, 0.7, 0.8, 0.9, 1.0, 2.0, or 3.0%, or any range or number therein) iridium, 0.0 to 0.5% (e.g., 0.0, 0.1, 0.2, 0.3, 0.4, or 0.5%, or any range or number therein) vanadium, 0.0 to 1.0% (e.g., 0.0, 0.1, 0.2, 0.3, 0.4, 0.5, 0.6, 0.7, 0.8, 0.9, or 1.0%, or any range or number therein) palladium, 0.0 to 1.0% (e.g., 0.0, 0.1, 0.2, 0.3, 0.4, 0.5, 0.6, 0.7, 0.8, 0.9, or 1.0%, or any range or number therein) platinum, 0.0 to 0.5% (e.g., 0.0, 0.1, 0.2, 0.3, 0.4, or 0.5%, or any range or number therein) silicon, 0.0 to 0.1% yttrium, 0.0 to 0.1% lanthanum, 0.0 to 0.1% cerium, 0.0 to 0.003% (e.g., 0.0, 0.001, 0.002, or 0.003%, or any range or number therein) sulphur, 0.0 to 0.25% (e.g., 0.0, 0.10, 0.20, or 0.25%, or any range or number therein) manganese, 0.0 to 0.1 magnesium, 0.0 to 4.0% (e.g., 0.0, 0.1, 0.2, 0.3, 0.4, 0.5, 0.6, 0.7, 0.8, 0.9, 1.0, 2.0, 3.0, or 4.0%, or any range or number therein) iron, 0.0 to 0.5% (e.g., 0.0, 0.1, 0.2, 0.3, 0.4, or 0.5%, or any range or number therein) copper, 0.0 to 2.0% (e.g., 0.0, 0.1, 0.2, 0.3, 0.4, 0.5, 0.6, 0.7, 0.8, 0.9, 1.0, or 2.0%, or any range or number therein) hafnium, the balance being nickel and incidental impurities. In one particular aspect, the nickel-based alloy composition can include greater than 0.05 wt. % carbon (e.g., 0.051, 0.052, 0.053, 0.054, 0.055, 0.056, 0.057, 0.058, 0.059, 0.06, 0.07, 0.08, 0.09, 0.1, 0.2, 0.3, or 0.35, or more, or any range or number therein).

Such a nickel based alloy has a particularly high level of creep resistance combined with a high level of AM processability. This superior combination of properties is achieved through co-optimisation of the factors which control creep (precipitation hardening (i.e. gamma prime fraction), matrix phase strengthening (as modelled by a creep merit index) and grain boundary strengthening (identified for this class of alloy for the first time by the present inventors and described below)) and factors which control AM processability (strain age cracking and hot cracking).

In an embodiment the following equation is satisfied in which W_{Nb} and W_{Ta} are the weight percent of niobium and tantalum in the alloy respectively

$$0.6 \leq 0.3 {W}_{Nb} + 0.15 {W}_{Ta} \\ preferably$$

$$0.625 \leq 0.3 {W}_{Nb} + 0.15 {W}_{Ta} \\ more preferably \\ 0.65 \leq 0.3 {W}_{Nb} + 0.15 {W}_{Ta}$$

Such an alloy has improved hot cracking resistance.

In an embodiment the following equation is satisfied in which W_{Al}, W_{Ti}W_{Nb} and W_{Ta} are the weight percent of aluminium, titanium, niobium and tantalum in the alloy respectively

$$5.6 \leq {W}_{Al} + 0.5 {W}_{Ti} + 0.3 {W}_{Nb} + 0.15 {W}_{Ta} \leq 7. \\ preferably \\ 5.6 \leq {W}_{Al} + 0.5 {W}_{Ti} + 0.3 {W}_{Nb} + 0.15 {W}_{Ta} \leq 6.5$$

Such an alloy has improved strain age cracking resistance.

In an embodiment the following equation is satisfied in which W_{W} and W_{Mo} are the weight percent of tungsten and molybdenum in the alloy respectively

$${W}_{W} + 0.65 {W}_{Mo} \geq 4. \\ preferably$$

$${W}_{W} + 0.65 {W}_{Mo} \geq 6. \\ more preferably \\ {W}_{W} + 0.65 {W}_{Mo} \geq 8.0$$

Such an alloy has improved creep resistance.

In an embodiment the nickel-based alloy composition consists of, in weight percent, 8.0% or more chromium, preferably 8.5% or more chromium, more preferably 9.0 or more chromium, more preferably 9.5% or more chromium, more preferably 9.75% or more chromium, most preferably 10.0% or more. Such an alloy has improved oxidation and corrosion resistance.

In an embodiment the nickel-based alloy composition consists of, in weight percent, 14.7% or less chromium, preferably 13.8% or less. Such an alloy has improved microstructural stability.

In an embodiment the nickel-based alloy composition consists of, in weight percent, 9.8 wt. % or less tantalum, preferably of 9.2% or less tantalum, more preferably of 7.1% or less tantalum, more preferably 6.3% or less tantalum, even more preferably 5.5% or less tantalum, yet more preferably 5.0 or less tantalum, most preferably 4.5% or less tantalum. Such an alloy has reduced density and optionally allows an increased tungsten content which helps increase creep resistance.

In an embodiment the nickel-based alloy composition consists of, in weight percent, 2.0% or less molybdenum, preferably 1.8% or less molybdenum, preferably 1.5% or less molybdenum, more preferably 1.4% or less molybdenum, most preferably 1.3% or less molybdenum. Such an alloy has improved hot corrosion resistance.

In an embodiment the nickel-based alloy composition consists of, in weight percent, 5.0% or less titanium, preferably 4.2% or less titanium, more preferably 3.0% or less titanium, more preferably 2.5% or less titanium, more preferably 2.0% or less titanium, more preferably 1.5% or less titanium, more preferably 1.4% or less titanium and most preferably 1.3 or less titanium, and even more preferably 1.2 wt. % titanium or less, or still more preferably 1.0 wt. % to 1.25 wt. % titanium. Such an alloy has better oxidation resistance.

In an embodiment the nickel-based alloy composition consists of, in weight percent, 10.7 or less tungsten, preferably 9.5% or less tungsten, more preferably 9.0% or less tungsten, even more preferably 8.7% or less tungsten, even more preferably 8.5% or less tungsten, most preferably 8.0 wt. % or less tungsten, most preferably 7.5 wt. % or less tungsten. Such an alloy has improved microstructural stability.

In an embodiment the nickel-based alloy composition consists of, in weight percent, 3.0% or less niobium, preferably 2.0% or less niobium. Such an alloy has improved oxidation resistance.

In an embodiment the nickel-based alloy composition consists of, in weight percent, 0.5% or less of one or both of platinum and palladium. Such an alloy has lower cost.

In an embodiment the nickel-based alloy composition consists of, in weight percent, 4.3% or more aluminium, preferably 4.5% or more aluminium. Such an alloy has improved corrosion resistance.

In an embodiment the nickel-based alloy composition consists of, in weight percent, 5.6% or less aluminium, preferably of 5.5% or less aluminium, more preferably 5.3% or less aluminium, even more preferably 5.2% or less aluminium, most preferably 5.1% or less aluminium. The strain age cracking resistance is improved in such an alloy in combination with improved hot cracking resistance.

In an embodiment the nickel-based alloy composition consists of, in weight percent, 15.0% or less cobalt, preferably 10.0% or less cobalt, more preferably 9.5% or less cobalt, more preferably 9.0% or less cobalt. Such an alloy has a lower freezing range.

In an embodiment the nickel-based alloy composition consists of, in weight percent 1.1 wt. % or more tantalum, preferably of 2.0% or more tantalum, more preferably of 2.5% or more tantalum. Such an alloy allows the amount of niobium to be reduced without reduction in hot cracking resistance, or in combination with higher levels of niobium, improves hot cracking resistance yet further.

In an embodiment the nickel-based alloy composition consists of, in weight percent 2.7 wt. % or more tungsten, preferably of 2.8% or more tungsten, more preferably of 4.7% or more tungsten, even more preferably of 5.1% or more tungsten, more preferably of 5.2% or more tungsten, most preferably 6.2 wt. % or more tungsten. Such an alloy has improved creep resistance.

In an embodiment the following equation is satisfied in which W_{Ta} and W_{W} are the weight percent of tantalum and tungsten in the alloy respectively

$${W}_{W} + {W}_{Ta} \leq 13.9 \\ preferably \\ {W}_{W} + {W}_{Ta} \leq 11.8$$

Such an alloy has reduced density.

In an embodiment the nickel-based alloy composition consists of, in weight percent, of 1.5 wt. % or less hafnium, preferably 1.2 wt. % or less hafnium, more preferably of 1.1 wt. % or less hafnium.

The nickel-based alloy composition of any of claims 1-23 consisting of, in weight percent, 1.2% or more titanium, preferably 1.3% or more titanium. Such an alloy has lower cost and improved oxidation resistance. Such an alloy has improved creep resistance.

In an embodiment the nickel-based alloy composition consists of, in weight percent, of 0.1 wt. % or more hafnium, preferably 0.2 wt. % or more hafnium, more preferably of 0.25 wt. % or more, more preferably 0.3 wt. % or more hafnium, even more preferably of 0.5 wt. % or more hafnium, even more preferably of 0.6 wt. % or more hafnium. Such an alloy has improved creep and oxidation resistance.

In an embodiment the nickel-based alloy composition consists of, in weight percent 5.5% or more cobalt, preferably 6.0% or more cobalt, more preferably 8.0 wt. % or more cobalt, preferably of 9.0 wt. % or more cobalt, more preferably of 10.0 wt. % or more cobalt.

Such an alloy has lower gamma prime solvus.

In an embodiment the nickel-based alloy composition consists of, in weight percent 0.05 wt. % or more niobium, preferably of 0.5 wt. % or more niobium, more preferably of 1.0 wt. % or more niobium. Such an alloy has improved resistance to hot cracking.

In an embodiment the nickel-based alloy composition consists of, in weight percent 0.1 wt. % or more molybdenum, preferably 0.2% molybdenum, more preferably 0.5% molybdenum. Such an alloy has higher tensile strength and creep resistance without increasing density dramatically.

In an embodiment the nickel-based alloy composition consists of, in weight percent, 0.005 wt. % or less zirconium, preferably 0.002 wt. % or less zirconium, more preferably 0.0015% or less zirconium. Such an alloy has lower propensity for hot cracking.

In an embodiment the nickel-based alloy composition consists of, in weight percent, 0.2% or less carbon, preferably 0.15% or less carbon, more preferably 0.10% or less carbon.

Such an alloy is less prone to cracking.

In an embodiment the nickel-based alloy composition consists of, in weight percent, 0.03 wt. % or less boron, preferably 0.02 wt. % or less boron, more preferably 0.018 wt. % or less boron, most preferably 0.015 wt. % or less boron or even 0.012 wt. % or less boron. Such an alloy has improved creep resistance.

In an embodiment the nickel-based alloy composition consists of, in weight percent, 0.008% or more boron. Such an alloy has increase creep strength.

In an embodiment the nickel-based alloy composition consists of, in weight percent, 2.9% or less rhenium, preferably 2.5% or less rhenium, more preferably 2.0% or less rhenium, most preferably 1.5% or less rhenium. Such an alloy has reduced cost.

In an embodiment the nickel-based alloy composition consists of, in weight percent, 0.1% or more rhenium, preferably 0.2% or more rhenium, more preferably 0.3% or more rhenium, more preferably 0.5% or more rhenium, most preferably 0.8% or more rhenium.

Such an alloy has increased strength, oxidation resistance and microstructural stability.

In an embodiment the nickel-based alloy composition consists of, in weight percent, 0.2% or less silicon, preferably 0.1% or less silicon, more preferably 0.05% or less silicon.

Such an alloy has improved processability.

In an embodiment, the nickel-based alloy composition comprises 0.06 wt. % carbon or more, preferably 0.07 wt. % carbon or more. Such an alloy has increase grain boundary strength, assisting in creep and fatigue resistance.

In an alternative aspect, the present invention provides a nickel-based alloy composition consisting, in weight percent, of: 4.0 to 6.0% aluminium, 1.1 to 6.0% titanium, 0.0 to 4.0% niobium, 0.0 to 11.9% tantalum, 2.0 to 12.7% tungsten, 0.0 to 3.0% molybdenum, 0.0 to 22.0% cobalt, 6.0 to 16.7% chromium, 0.02 to 0.35% carbon, 0.001 to 0.2% boron, 0.00 to 0.01% zirconium, 0.0 to 3.0% rhenium, 0.0 to 3.0% ruthenium, 0.0 to 3.0% iridium, 0.0 to 0.5% vanadium, 0.0 to 1.0% palladium, 0.0 to 1.0% platinum, 0.0 to 0.5% silicon, 0.0 to 0.1% yttrium, 0.0 to 0.1% lanthanum, 0.0 to 0.1% cerium, 0.0 to 0.003% sulphur, 0.0 to 0.25% manganese, 0.0 to 0.1 magnesium, 0.0 to 4.0% iron, 0.0 to 0.5% copper, 0.3 to 2.0% hafnium, the balance being nickel and incidental impurities and wherein the following equation is satisfied in which W_{Nb} and W_{Ta} are the weight percent of niobium and tantalum in the alloy respectively

$$0.6 \leq 0.3 {W}_{Nb} + 0.15 {W}_{Ta}$$

In another alternative aspect, the present invention provides a powder of a nickel-based alloy composition consisting, in weight percent, of: 4.0 to 6.0% aluminium, 1.1 to 6.0% titanium, 0.0 to 4.0% niobium, 0.0 to 11.9% tantalum, 2.0 to 12.7% tungsten, 0.0 to 3.0% molybdenum, 0.0 to 22.0% cobalt, 6.0 to 16.7% chromium, 0.02 to 0.35% carbon, 0.001 to 0.2% boron, 0.00 to 0.01% zirconium, 0.0 to 3.0% rhenium, 0.0 to 3.0% ruthenium, 0.0 to 3.0% iridium, 0.0 to 0.5% vanadium, 0.0 to 1.0% palladium, 0.0 to 1.0% platinum, 0.0 to 0.5% silicon, 0.0 to 0.1% yttrium, 0.0 to 0.1% lanthanum, 0.0 to 0.1% cerium, 0.0 to 0.003% sulphur, 0.0 to 0.25% manganese, 0.0 to 0.1 magnesium, 0.0 to 4.0% iron, 0.0 to 0.5% copper, 0.1 to 2.0% hafnium, the balance being nickel and incidental impurities.

In another aspect, the present invention provides, optionally in powder form, a nickel-based alloy composition consisting, in weight percent, of: 4.6 to 5.0% aluminium, 1.1 to 1.35% titanium, 0.5 to 2.0% niobium, 2.5 to 4.5% tantalum, 6.2 to 7.6% tungsten, 0.5 to 1.8% molybdenum, 8.0 to 9.1% cobalt, 9.6 to 10.5% chromium, 0.06 to 0.35% carbon, 0.001 to 0.2% boron, 0.002 to 0.004% zirconium, 0.2 to 1.5% rhenium, 0.0 to 3.0% ruthenium, 0.0 to 3.0% iridium, 0.0 to 0.5% vanadium, 0.0 to 1.0% palladium, 0.0 to 1.0% platinum, 0.0 to 0.5% silicon, 0.0 to 0.1% yttrium, 0.0 to 0.1% lanthanum, 0.0 to 0.1% cerium, 0.0 to 0.003% sulphur, 0.0 to 0.25% manganese, 0.0 to 0.1 magnesium, 0.0 to 4.0% iron, 0.0 to 0.5% copper, 0.8 to 1.2% hafnium, the balance being nickel and incidental impurities and optionally wherein the following equation is satisfied in which W_{Nb} and W_{Ta} are the weight percent of niobium and tantalum in the alloy respectively

$$0.6 \leq 0.3 {W}_{Nb} + 0.15 {W}_{Ta} .$$

The term “consisting of” is used herein to indicate that 100% of the composition is being referred to and the presence of additional components is excluded so that percentages add up to 100%. Unless otherwise stated, percents are expressed in weight percent.

### BRIEF DESCRIPTION OF THE DRAWINGS

FIG. 1 shows the calculated values for strain age merit index and hot cracking index for a number of commercially used superalloys (including alloys listed in Table 1), limits for creep resistance, stain age cracking and hot cracking are identified, the target area for the invention is shaded.

FIG. 2 is a contour plot showing the effect of γ′ forming elements aluminium and niobium plus tantalum (according to the relationship 0.3W_{Nb}+0.15W_{Ta}) on volume fraction of γ′, determined from phase equilibrium calculations conducted at 900° C. Delineated on the graph are different limits for strain age index and hot cracking index.

FIG. 3 is a contour plot showing the effect of γ′ forming elements aluminium and niobium plus tantalum (according to the relationship 0.3W_{Nb}+0.15W_{Ta}) on hot cracking index, determined from phase equilibrium calculations conducted at 900° C.

FIG. 4 is a contour plot showing the effect of γ′ volume fraction and creep merit index on creep temperature capability, contours have been normalised to IN713C alloy, the predicted position for alloys listed in Table 1 is shown.

FIG. 5 is a contour plot showing the effect of elements molybdenum and tungsten on creep merit index, delineated on the graph are limits for stability at different concentrations of chromium.

FIG. 6 is a contour plot showing the effect of elements molybdenum and tungsten on alloy stability (in terms of Md number) when the chromium content is fixed at 6.0 wt. %, delineated on the graph are different levels for creep merit index.

FIG. 7 is a contour plot showing the effect of elements molybdenum and tungsten on alloy stability (in terms of Md number) when the chromium content is fixed at 8.0 wt. %, delineated on the graph are different levels for creep merit index.

FIG. 8 is a contour plot showing the effect of elements molybdenum and tungsten on alloy stability (in terms of Md number) when the chromium content is fixed at 10.0 wt. %, delineated on the graph are different levels for creep merit index.

FIG. 9 is a contour plot showing the effect of elements molybdenum and tungsten on alloy stability (in terms of Md number) when the chromium content is fixed at 12.0 wt. %, delineated on the graph are different levels for creep merit index.

FIG. 10 is a contour plot showing the effect of elements molybdenum and tungsten on alloy stability (in terms of Md number) when the chromium content is fixed at 14.0 wt. %, delineated on the graph are different levels for creep merit index.

FIG. 11 is a contour plot showing the effect of elements molybdenum and tungsten on alloy stability (in terms of Md number) when the chromium content is fixed at 16.0 wt. %, delineated on the graph are different levels for creep merit index.

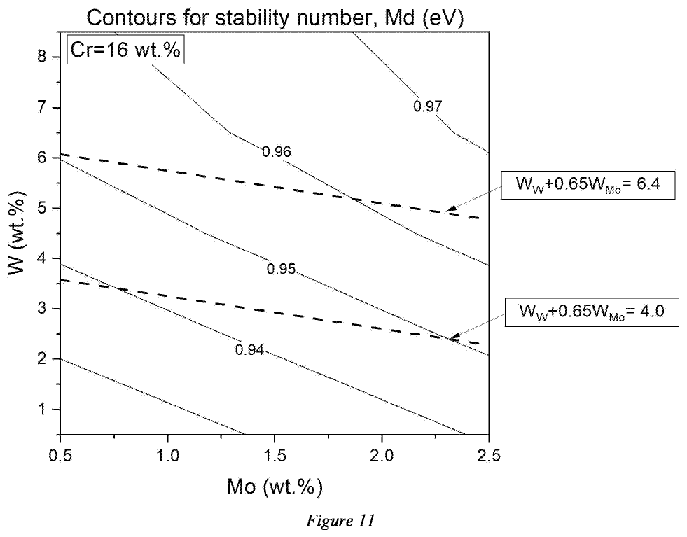

FIG. 12 is a contour plot showing the effect of elements tantalum and tungsten on alloy density.

FIG. 13 is a contour plot showing the effect of strain age cracking index and cobalt on alloy solidification range.

FIG. 14 shows creep results for additively manufactured CM247 compared with results for examples of the alloy invention (examples 1 and 2 are not tested to failure, whereas CM247 was tested to failure).

### DETAILED DESCRIPTION OF THE INVENTION

Traditionally, nickel-based superalloys have been designed through empiricism. Thus their chemical compositions have been isolated using time consuming and expensive experimental development, involving small-scale processing of limited quantities of material and subsequent characterisation of their behaviour. The alloy composition adopted is then the one found to display the best, or most desirable, combination of properties. The large number of possible alloying elements indicates that these alloys are not entirely optimised and that improved alloys are likely to exist.

In superalloys, generally additions of chromium (Cr) and aluminium (Al) are added to impart resistance to oxidation/corrosion, cobalt (Co) is added to improve resistance to sulphidisation. For creep resistance, molybdenum (Mo), tungsten (W), cobalt are introduced, because these retard the thermally-activated processes—such as, dislocation climb—which determine the rate of creep deformation. To promote static and cyclic strength, aluminium (Al), tantalum (Ta), niobium (Nb) and titanium (Ti) are introduced as these promote the formation of the precipitate hardening phase gamma-prime (γ′). This precipitate phase is coherent with the face-centred cubic (FCC) matrix phase which is referred to as gamma (γ).

A modelling-based approach used for the isolation of new grades of nickel-based superalloys is described here, termed the “Alloys-By-Design” (ABD) method. This approach utilises a framework of computational materials models to estimate design relevant properties across a very broad compositional space. In principle, this alloy design tool allows the so-called inverse problem to be solved; identifying optimum alloy compositions that best satisfy a specified set of design constraints.

The first step in the design process is the definition of an elemental list along with the associated upper and lower compositional limits. The compositional limits for each of the elemental additions considered in this invention—referred to as the “alloy design space”—are detailed in Table 2.

TABLE 2
Alloys design space in wt. % searched using
the “Alloys-by-Design” method.

| Alloy (wt. %) | Al | Co | Cr | Mo | Nb | Ta | Ti | W |
|---|---|---|---|---|---|---|---|---|
| Min | 2.0 | 0.0 | 2.0 | 0.0 | 0.0 | 0.0 | 0.0 | 0.0 |
| Max | 10.0 | 25.0 | 20.0 | 8.0 | 6.0 | 14.0 | 8.0 | 16.0 |

The balance is nickel. The levels of carbon, boron and zirconium where fixed at 0.06%, 0.015% and 0.06% respectively.

The second step relies upon thermodynamic calculations used to calculate the phase diagram and thermodynamic properties for a specific alloy composition. Often this is referred to as the CALPHAD method (CALculation of PHAse Diagrams). These calculations are conducted at the typical service temperature for the new alloy (900° C.), providing information about the phase equilibrium (microstructure).

A third stage involves isolating alloy compositions which have the desired microstructural architecture. In the case of nickel-based superalloys which require superior resistance to creep deformation, the creep rupture life generally improves as the volume fraction of the precipitate hardening phase γ′ is increased, the most beneficial range for volume fraction of γ′ lies between 60%-70%. At values above 70% volume fraction of γ′ a reduction in creep resistance is observed.

It is also necessary that the γ/γ′ lattice misfit should conform to a small value, either positive or negative, since coherency is otherwise lost; thus limits are placed on its magnitude. The lattice misfit δ is defined as the mismatch between γ and γ′ phases, and is determined according to

$$δ = \frac{2 ( {a}_{{γ}^{′}} - {a}_{γ} )}{{a}_{{γ}^{′}} + {a}_{γ}} \qquad ( 1 )$$

where a_{γ} and a_{γ′} are the lattice parameters of the γ and γ′ phases.

Rejection of alloy on the basis of unsuitable microstructural architecture is also made from estimates of susceptibility to topologically close-packed (TCP) phases. The present calculations predict the formation of the deleterious TCP phases sigma (σ), P and mu (μ) using CALPHAD modelling.

Thus the model isolates all compositions in the design space which are calculated to result in a desired volume fraction of γ′, which have a lattice misfit γ′ of less than a predetermined magnitude and have a total volume fraction of TCP phases below a predetermined magnitude.

In the fourth stage, merit indices are estimated for the remaining isolated alloy compositions in the dataset. Examples of these include: creep-merit index (which describes an alloy's creep resistance based solely on mean composition), strength-merit index (which describes an alloy's precipitation yield strength based solely on mean composition), solid-solution merit index (which describes an alloy's solid solution yield strength based solely on mean composition), density and cost.

In the fifth stage, the calculated merit indices are compared with limits for required behaviour, these design constraints are considered to be the boundary conditions to the problem. All compositions which do not fulfil the boundary conditions are excluded. At this stage, the trial dataset will be reduced in size quite markedly.

The final, sixth stage involves analysing the dataset of remaining compositions. This can be done in various ways. One can sort through the database for alloys which exhibit maximal values of the merit indices—the lightest, the most creep resistant, the most oxidation resistant, and the cheapest for example. Or alternatively, one can use the database to determine the relative trade-offs in performance which arise from different combination of properties.

The example seven merit indices are now described.

The first merit index is the creep merit index. The overarching observation is that time-dependent deformation (i.e. creep) of a nickel-based superalloy occurs by dislocation creep with the initial activity being restricted to the γ phase. Thus, because the fraction of the γ′ phase is large, dislocation segments rapidly become pinned at the γ/γ′ interfaces. The rate-controlling step is then the escape of trapped configurations of dislocations from γ/γ′ interfaces, and it is the dependence of this on local chemistry—in this case composition of the γ phase—which gives rise to a significant influence of alloy composition on creep properties.

A physically-based microstructure model can be invoked for the rate of accumulation of creep strain a when loading is uniaxial and along the [symbol] 001 [symbol] crystallographic direction. The equation set is

$${\dot{ε}}_{〈 001 〉} = \frac{16}{\sqrt{6}} {ρ}_{m} {ϕ}_{p} {D}_{eff} ( 1 - {ϕ}_{p} ) ( 1 / {ϕ}_{p}^{1 / 3} - 1 ) sinh \{ \frac{σ {b}^{2} ω}{\sqrt{6} {K}_{CF} k T} \} \qquad ( 2 )$$

$${\dot{ρ}}_{m} = C {\dot{ε}}_{〈 001 〉} \qquad ( 3 )$$

where ρₘ is the mobile dislocation density, φₚ is the volume fraction of the γ′ phase, and co is width of the matrix channels. The terms σ and T are the applied stress and temperature, respectively. The terms b and k are the Burgers vector and Boltzmann constant, respectively. The term

$${K}_{CF} = 1 + 2 {ϕ}_{p}^{1 / 3} / 3 \sqrt{3 π} ( 1 - {ϕ}_{p}^{1 / 3} )$$

is a constraint factor, which accounts for the close proximity of the cuboidal particles in these alloys. Equation 3 describes the dislocation multiplication process which needs an estimate of the multiplication parameter C and the initial dislocation density. The term D_{eff} is the effective diffusivity controlling the climb processes at the particle/matrix interfaces.

Note that in the above, the composition dependence arises from the two terms φₚ and D_{eff}. Thus, provided that the microstructural architecture is assumed constant (microstructural architecture is mostly controlled by heat treatment) so that φₚ is fixed, any dependence upon chemical composition arises through D_{eff}. For the purposes of the alloy design modelling described here, it turns out to be unnecessary to implement a full integration of Equations 2 and 3 for each prototype alloy composition. Instead, a first order merit index M_{creep} is employed which needs to be maximised, which is given by

$${M}_{creep} = {\sum }_{i} {x}_{i} / {\tilde{D}}_{i} \qquad ( 4 )$$

where xᵢ is the atomic fraction of solute i in the γ phase and \tilde{D}ᵢ is the appropriate interdiffusion coefficient.

The second merit index is for strength merit index. For high nickel-based superalloys, the vast majority of strength comes from the precipitate phase. Therefore, optimising alloy composition for maximal precipitate strengthening is a critical design consideration. From hardening theory, a merit index for strength, M_{strength}, is proposed. The index considers the maximum possible precipitate strength—determined to be the point where the transition from weakly coupled to strongly coupled dislocation shearing occurs—which can be approximated using,

$${M}_{strength} = \overline{M} \cdot \frac{1}{2} {γ}_{APB} {∅}_{p}^{1 / 2} / b \qquad ( 5 )$$

Where M̅ is the Taylor factor, γ_{APB} is the anti-phase boundary (APB) energy, φₚ is the volume fraction of the γ′ phase and b is the Burgers vector.

From Equation 5 it is apparent that fault energies in the γ′ phase—for example, the anti-phase boundary APB energy—have a significant influence on the deformation behaviour of nickel-based superalloys. Increasing the APB energy has been found to improve mechanical properties including, tensile strength and resistance to creep deformation. The APB energy was studied for a number of Ni—Al—X systems using density functional theory. From this work the effect of ternary elements on the APB energy of the γ′ phase was calculated, linear superposition of the effect for each ternary addition was assumed when considering complex multicomponent systems, resulting in the following equation,

$${γ}_{APB} = 195 - 1.7 {x}_{Cr} - 1.7 {x}_{Mo} + 4.6 {x}_{W} + 27.1 {x}_{T a} + 21.4 {x}_{Nb} + 15 {x}_{Ti} \qquad ( 6 )$$

where, x_{Cr}, x_{Mo}, x_{W}, x_{Ta}, x_{Nb} and x_{Ti} represent the concentrations, in atomic percent, of chromium, molybdenum, tungsten, tantalum, niobium and titanium in the γ′ phase, respectively. The composition of the γ′ phase is determined from phase equilibrium calculations.

The third merit index is density. The density, ρ, was calculated using a simple rule of mixtures and a correctional factor, where, ρₜ, is the density for a given element and xᵢ is the atomic fraction of the alloy element.

$$ρ = 1.05 [ {\sum }_{i} {x}_{i} {ρ}_{i} ] \qquad ( 7 )$$

The fourth merit index was cost. In order to estimate the cost of each alloy a simple rule of mixtures was applied, where the weight fraction of the alloy element, xᵢ, was multiplied by the current (2016) raw material cost for the alloying element, cᵢ.

$$Cost = {\sum }_{i} {x}_{i} {c}_{i} \qquad ( 8 )$$

The estimates assume that processing costs are identical for all alloys, i.e. that the product yield is not affected by composition.

A fifth merit index is based upon rejection of candidate alloys on the basis of unsuitable microstructural architecture made on the basis of susceptibility to TCP phases. To do this use is made of the d-orbital energy levels of the alloying elements (referred as Md) to determine the total effective Md level according to

$$\overline{{M}_{d}} = {\sum }_{i} {x}_{i} {Md}_{i} \qquad ( 9 )$$

where the xᵢ represents the mole fraction of the element i in the alloy. Higher values of Md are indicative of higher probability of TCP formation.

The sixth merit index is a strain age cracking index. The ability of an alloy to be processed by additive manufacturing is related to the chemical composition. The index is developed from the empirical observations which relate alloy composition to the weldability of nickel-based superalloys in terms of susceptibility to strain age cracking. In this relationship a factor of 0.5 is added to the titanium content to convert this to an “aluminium equivalent” as titanium has approximately twice the density of aluminium. In effect the additive manufacturing process for metallic alloys is a continuous welding process. There has been adaption of previous observations which only relate weldability to aluminium and titanium content. A modification is included to account for the influence of tantalum and niobium, which behave in a similar manner to aluminium and titanium during alloy aging. Similar to titanium a constant is added to convert these elemental additions to an “aluminium equivalent”, thus, niobium and tantalum have correctional factors (determined from their density relative to aluminium) of 0.3 and 0.15 respectively. The strain age index is applied via the following equation.

$${M}_{strain - age} = ( {W}_{Al} + 0.5 {W}_{Ti} + 0.3 {W}_{Nb} + 0.15 {W}_{Ta} ) \qquad ( 10 )$$

where W_{Al}, W_{Ti}, W_{Nb}, and W_{Ta} the weight percent of aluminium, titanium, niobium and tantalum in the alloy by weight percent. A lower value of this strain age index indicates a better response to the additive manufacture process.

A seventh merit index is based on the solidification behaviour of candidate alloys as predicted by the Scheil-Gulliver model, in order to rank susceptibility to hot cracking based on composition. In this approach the temperature range of the terminal stage of solidification, between 90% and 99% fraction solid, is taken to represent the region where an alloy is vulnerable to hot cracking, as it is in this phase that liquid feeding is likely to be restricted by bridged networks of solid material. The temperature range of 40% to 90% of solid fraction is considered to be the safe region, since liquid feeding is far less restricted in this stage; the temperature range before 40% fraction solid is not considered to be relevant because liquid is still the predominant phase.

According to the ranking system used by Clyne and Davis for alloy castings, the hot cracking index is defined as the ratio of the vulnerable temperature range to the safe temperature range, as follows:

$$HCI = \frac{{T}_{90} - {T}_{99}}{{T}_{40} - {T}_{90}} \qquad ( 11 )$$

Lower values of this index correspond to a lower risk of hot cracking.

The ABD method described above was used to isolate the inventive alloy composition. The design intent for this alloy is to develop a highly creep resistant superalloy—achieved by having a high volume fraction of γ′—combined with improved processability by additive manufacturing compared to other high volume γ′ alloys—achieved by having an improved resistance to strain age cracking and to the mechanism of hot cracking. Alongside these attributes a good resistance to oxidation is achieved by having sufficient levels of aluminium to form a protective aluminium-based oxide scale and other key material properties including microstructural stability and alloy density are optimised.

The material properties—determined using the ABD method—for the typical compositions, listed in Table 1, are listed in Table 3. The design of the new alloy was considered in relation to the predicted properties listed for these alloys.

The rationale for the design of the new alloy is now described.

TABLE 3
Calculated phase fractions and merit indices made with the “Alloys-by-
Design” software. Results for nickel-based superalloys listed in Table 1.

| | | | | | Strength | | | | | |
|---|---|---|---|---|---|---|---|---|---|---|
| | | Creep Merit | | γ/γ′ | Merit | | Strain | Hot | Freezing | |
| | | Index | Density | Misfit | Index | Md | Age | Cracking | Range | Cost |
| Alloy | γ′ | (m⁻²s × 10⁻¹⁵) | (g/cm³) | (%) | (Mpa) | (eV) | Index | Index | (° C.) | $/Kg |
| IN738 | 0.45 | 5.9 | 8.3 | 0.16 | 1517 | 0.92 | 5.6 | 1.82 | 259 | 5.54 |
| CM247LC | 0.59 | 8.0 | 8.6 | −0.05 | 1243 | 0.92 | 6.3 | 4.44 | 606 | 10.63 |
| IN713 | 0.55 | 5.8 | 8.0 | −0.35 | 1139 | 0.93 | 7.0 | 2.03 | 213 | 2.59 |
| IN792 | 0.51 | 6.5 | 8.5 | 0.17 | 1702 | 0.92 | 5.9 | 2.05 | 269 | 7.54 |

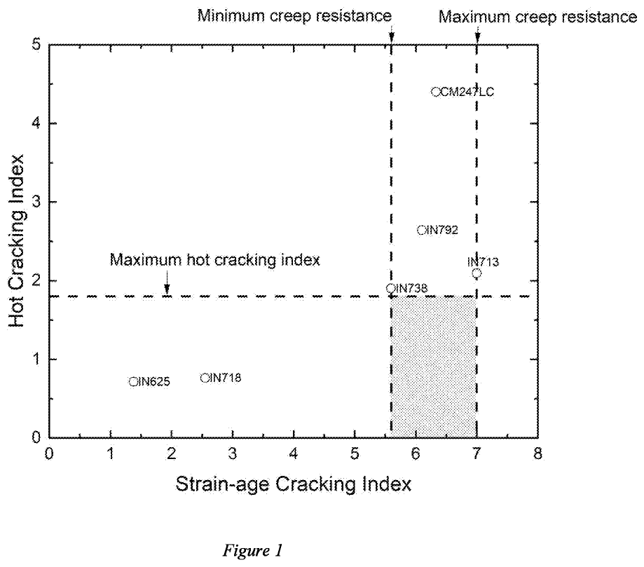

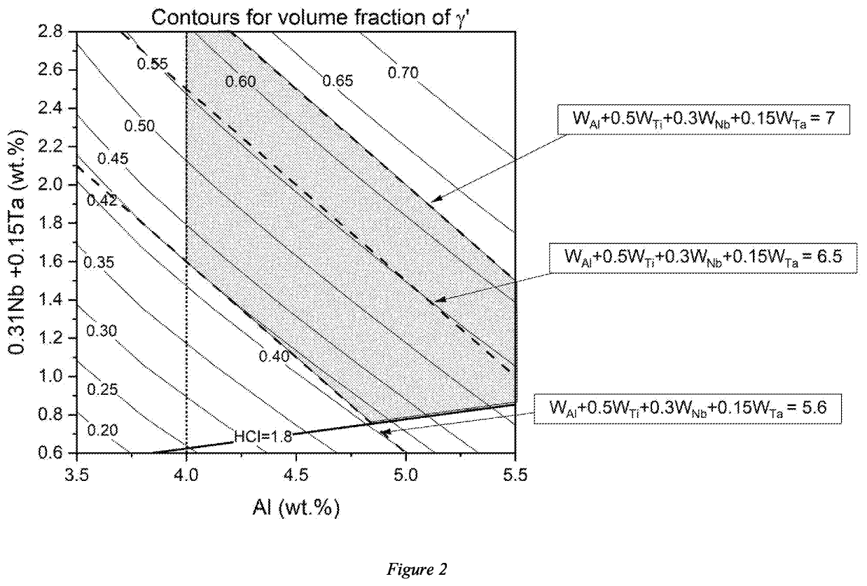

The use of high γ′ volume fraction superalloys with compositions originally designed for casting processes has some limitations. For the alloys in Table 1 they are limited by a lower creep performance than the cast equivalent and difficulties related to cracking defects during processing. Selected factors which control creep resistance and propensity to cracking are linked making this trade-off difficult to optimise, for example, increased propensity to strain age cracking index correlates with a higher γ′ volume fraction (FIG. 2). Therefore optimising the balance between these two factors must be carefully managed so an optimum balance of creep strength and resistance to cracking is achieved. FIG. 1 shows the narrow range for a strain-age index which allows for a high level of creep resistance (as achieved by having a high γ′ volume fraction, i.e. ignoring creep merit index and grain boundary precipitation) combined with a sufficient AM processing window to significantly reduce or eliminate strain age cracking. Good processing by AM is only achieved when the strain age cracking index is low and in combination with a low hot cracking index, which is another cracking mechanism during AM that results from the solidification process during remelting of the metal in an AM process.

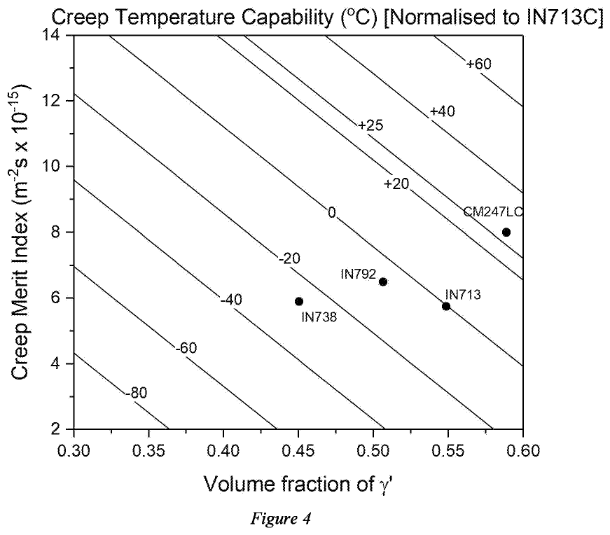

To achieve a high level of creep resistance in the range of γ′ volume fraction required for this invention the strength of the γ matrix phase is preferably sufficiently high, this is determined in terms of creep merit index (FIG. 4). Also the present inventors have found that the strength of grain boundaries, which provides resistance to grain boundary cracking or sliding during creep, is desirably controlled in order to achieve a high level of creep resistance, particularly the formation of titanium carbides which have a high reaction kinetics and a high thermodynamic stability.

FIG. 2 describes the relationship between the addition of elements aluminium, niobium and tantalum which are predominantly added to form the γ′ phase and control the volume fraction of γ′.

The elements which form the γ′ phase may reduce the ease by which an alloy can be processed by AM due to an increasing strain age merit index (Equation 10). Thus the combination of these elements must be optimised to provide the desired balance between limiting likelihood of strain age cracking during AM processing and volume fraction of γ′ (which provides strength in terms of creep resistance and tensile strength).

To achieve the preferred strain age cracking index the aluminium, titanium, niobium and tantalum content must satisfy the following constraint

$$f ( SAC ) = {W}_{Al} + 0.5 {W}_{Ti} + 0.3 {W}_{Nb} + 0.15 {W}_{Ta}$$

where, f(SAC) is a numerical value of 7.0 or less and WAI, W_{Ti}, W_{Nb} and W_{Ta} are the weight percent of aluminium, titanium, niobium and tantalum in the alloy respectively. A value of 7.0 or less is selected to be equivalent or better than alloy IN713C, see Table 3. Values for f(SAC) greater than 7 are less preferable because they limit the processing of the alloy in terms of strain age cracking. It is preferable to lower the strain age merit index, to enable easier processing by AM, so preferably W_{Al}+0.5W_{Ti}+0.3W_{Nb}+0.15W_{Ta}≤6.5.

The intended application temperature for this new alloy is up to temperatures of 1000° C. in highly oxidising and corrosive environments. Examples of the application areas include hot sections of a gas turbine engine or within the exhaust system of an internal combustion engine.

To achieve desirable oxidation performance it is desired that the alloy of the invention must form a protective aluminium-based oxide scale (Al₂O₃), as such oxides are stable at and above 1000° C. as opposed to those based on Cr₂O₃. Alloys such as IN738 and IN792 have a relatively high volume fraction of γ′ and very good creep resistance but their relatively low aluminium content—3.4 wt. % and 3.2 wt. %, respectively—means they are unable to form an aluminium-based protective oxide scale, instead they form a less protective chromium based oxide scale. An aluminium-based oxide scale has better adhesion and thermal stability in comparison to chromium-based protective oxide scales which may encounter chromium volatisation at temperatures close to 1000° C., resulting in a less protective oxide. To produce an aluminium-based protective oxide scale an aluminium content of at least 4.0 wt. % is required, preferably 4.3 wt. % or more and more preferably 4.5 wt. % or more as this further improves the formation of the alumina scale providing better oxidation resistance.

Described later in reference to improving alloy creep resistance, a titanium content of 1.1 wt. % or greater is used in order to improve creep resistance by increasing the gamma-prime strengthening in the alloy and also by stabilising carbides to pin grain boundaries at elevated temperatures. Based upon the minimum limit of aluminium (4.0 wt. %) and the preferred minimum limit of aluminium (4.5 wt. %) the maximum titanium is 6.0 wt. % and preferably 5.0 wt. % respectively to achieve an f(SAC)<7.0 and f(SAC)<6.5 respectively. Based upon a titanium content of at least 1.1 wt. % the maximum aluminium content is limited to 6.45 wt. %, more preferably 5.95 wt. % to achieve f(SAC)<7.0 and f(SAC)<6.5 respectively. However, as will become apparent from the below, aluminium is limited to 6.0 wt. % in order for the hot cracking performance to be improved. In a preferred embodiment the alloy has 1.2 wt. % or more titanium, yet further to increase creep strength and in a most preferred embodiment the alloy has 1.3 wt. % or more titanium. In an embodiment where strain age cracking resistance is optimised over creep strength, titanium is limited to 3.0 wt. % or less, preferably titanium is limited to 2.0 wt. % or less, more preferably 1.5 wt. % or less titanium, more preferably 1.4 wt. % or less titanium and most preferably 1.3 wt. % or less titanium (or 1.35 wt. % or less titanium) and even more preferably 1.2 wt. % or less titanium. In an embodiment the alloy has 1.1 wt. % to 1.25 wt. % titanium to achieve a balance between creep strength and strain age cracking resistance.

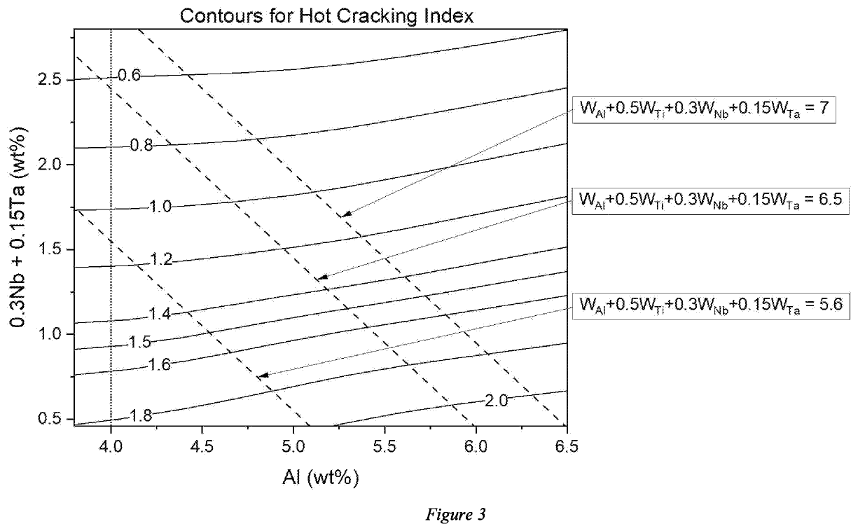

Alloying additions of niobium and titanium are known to reduce oxidation performance. Niobium forms grain boundary carbides which are particularly detrimental for oxidation assisted cracking mechanisms in which damage may accumulate along grain boundaries, such as under low cycle fatigue, creep-fatigue conditions or during high temperature creep. Titanium accelerates oxide scale growth and forms as rutile above and below protective oxide scales based on Al₂O₃ and Cr₂O₃, this is undesirable as this may also adversely affect mechanical performance. However, additions of niobium are beneficial for improving resistance to hot cracking (discussed later with reference to FIG. 3) and its use is optional but limited to 4.0 wt. %, more preferably 3.0 wt. % or less, even more preferably 2.0 wt. % or less to achieve a desirable balance of resistance to hot cracking while achieving a good oxidation resistance. Titanium has a less negative effect on oxidation than niobium because of its lower Pilling-Bedworth ratio. The Pilling-Bedworth ratio describes the volume expansion of a metal when it is oxidised. This volume expansion results in stresses around the oxide which can result in cracking, the Pilling-Bedworth ratios for niobium and titanium are 2.69 and 1.73 respectively. Alloys IN792 and In738 still show acceptable levels of oxidation even with relatively high titanium contents. The present alloy has high creep resistance due to the high levels of titanium and has a correspondingly reduced resistance to oxidation, but this balance of properties is useful in some circumstances and resistance to oxidation can be mitigated in other ways such as coating the article or controlling the environment in which the article operates. However when better resistance to oxidation is important, it is preferred that titanium is less than 4.2 wt. % (IN792), more preferably less than 3.4 wt. % (IN738) and most preferably less than 2.5 wt. %. As described elsewhere, to achieve an even better level of oxidation resistance aluminium and chromium additions can be increased and in some embodiments this compensates for the higher levels of titanium which can reduce oxidation resistance. Increasing the aluminium and chromium levels beyond the minimum allowable described elsewhere improves oxidation resistance by increasing aluminium activity in the alloy (G. S. Giggins et al., Oxidation of Ni—Cr—Al Alloys Between 10000 and 1200° C., Journal of The Electrochemical Society, 118(1971),1782) which encourages more rapid growth of an alumina oxide scale. Preferably more than 4.3 wt. % of aluminium and/or more than 8.0 wt. % chromium is added. In an embodiment chromium is at least 8.5 wt. % or even 9.0 wt. %, or 9.5 wt. % or 9.75 wt. % for increased oxidation resistance, irrespective of aluminium content. More preferably aluminium content is at least 4.5 wt. % (or even 4.6 wt. % or more aluminium) and/or chromium content is at least 10.0 wt. %.

Additions of chromium will promote the formation a protective alumina oxide scale. Chromium in particular is desirable for improving resistance to hot corrosion. Alloys such as IN738 and IN792 have relatively high level of chromium—16.0 wt. % and 12.7 wt. %, respectively—this is primarily for resistance to hot corrosion, however, the maximum operating temperature is limited as they have poor oxidation kinetics at very high temperatures as they do not form protective aluminium-based oxides. The upper limit of operating temperature for these alloys is also limited as they have a lower resistance to creep relative to IN713C (FIG. 4). The alloy of this invention requires a chromium content of 6.0 wt. % or greater. A chromium level of 6.0 wt. % or greater is desirable in order to achieve a good level of hot corrosion resistance and creep resistance. As discussed later in relation to creep, chromium additions in combination with controlled levels boron are desirable to achieve a high creep resistance through formation M5B3 type of chromium boride precipitates which are very stable at high temperature and promote grain boundary strengthening (P. Kontis et al., Atomic-scale grain boundary engineering to overcome hot-cracking in additively manufactured superalloys, Acta Materialia, 177 (2019), 209-221). More preferably the chromium content is 8.0 wt. % or greater as this provides hot corrosion resistance equivalent to CM247LC. Even more preferably chromium is present in an amount of 9.6% or more chromium or 10.0% or greater as this increases the corrosion resistance in comparison to alloy CM247LC even further. Even greater corrosion resistance is achieved by increasing chromium to a minimum of 10.1 wt. %, for example 10.1 wt. % to 10.5 wt. % chromium in the alloy.

Molybdenum is known to reduce the hot corrosion resistance of nickel superalloys significantly. Molybdenum also has the advantage of providing high levels of strength to the gamma matrix phase which is beneficial for improving tensile strength and creep resistance. As such molybdenum is an optional addition but a preferred minimum of 0.1 wt. % or more or 0.2 wt. % or more results in an alloy with improved tensile strength and creep resistance and these benefits are achieved using a lower density material than other elements which have a similar technical effect, particularly tungsten and rhenium. It is desirable to use minimum level of molybdenum or 0.5 wt. % greater further to increase strength and creep resistance. To achieve a good level of corrosion resistance it molybdenum is limited to 3.0 wt. % or less. Preferably molybdenum is limited to 2.0 wt. % or less. More preferably molybdenum is limited to 1.8 wt. % or less as alloys IN738 and IN792 are known to have a very good resistance to corrosion. Even better corrosion performance is achieved in embodiments where the alloy has 1.5% or less molybdenum, or 1.4% or less molybdenum, or even 1.3% or less molybdenum.

Based upon the minimum content for aluminium (4.0 wt. %) and the desirability for f(SAC)<7, as well as the requirement to include a minimum of 1.1 wt. % titanium, it is necessary to limit the sum of the elements tantalum and niobium according to the relationship 0.3W_{Nb}+0.15W_{Ta} to 2.45 or less. Therefore, the maximum limits of niobium and tantalum should be 8.1 wt. % and 16.3 wt. % respectively. However the alloy is limited to even lower amounts of niobium and tantalum to ensure adequate microstructural stability (tantalum) and oxidation resistance (niobium). Preferably for an improved balance of oxidation resistance (aluminium 4.5 wt. % or greater) and strain age cracking resistance (f(SAC)<6.5) 0.3W_{Nb}+0.15W_{Ta} is limited to 1.95 or less. Therefore the maximum limit of niobium and tantalum should more preferably be 4.8 wt. % and 9.7 wt. % respectively. Most preferably a balance of resistance to strain age cracking and oxidation resistance is achieved when aluminium is 5.0 wt. % and f(SAC)<6.5, therefore it is most preferable to limit 0.3W_{Nb}+0.15W_{Ta} to 1.45 or less. Therefore the maximum limit of niobium and tantalum should be 3.2 wt. % and 6.3 wt. % respectively.

Plotted on FIG. 2 are dotted lines depicting different limits for strain age cracking. It is seen that to produce an alloy which has a strain age index of less than 7 it is preferable that the γ′ volume fraction is limited to 0.63 at an equilibrium temperature of 900° C. Preferably the volume fraction of γ′ volume fraction is limited to 0.56 based on the more preferred value for strain age index W_{Al}+0.5W_{Ti}+0.3W_{Nb}+0.15W_{Ta}≤6.5.

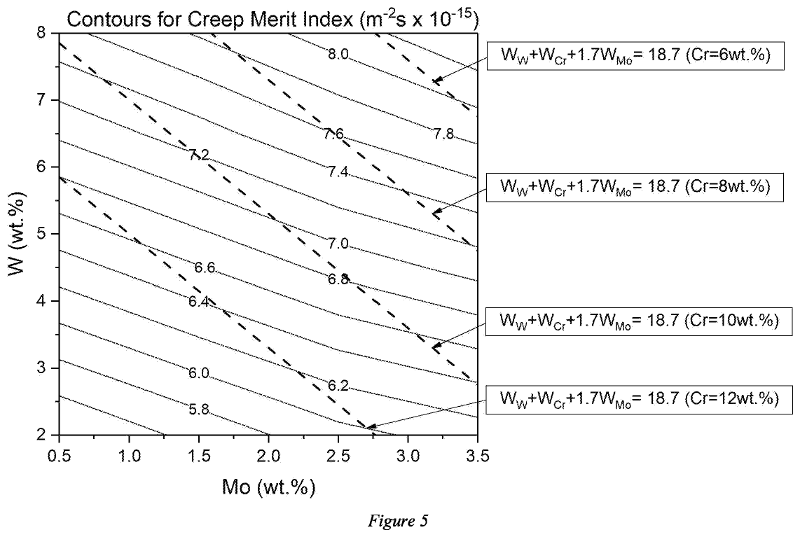

The desirable minimum requirement for volume fraction of γ′ is 0.42, described later in relation to achieving required creep resistance using FIG. 4 and FIG. 5. To achieve the desired volume fraction of γ′ the aluminium, titanium niobium and tantalum content must satisfy the following constraint

$$f ( {γ}^{′} ) = {W}_{Al} + 0.5 {W}_{Ti} + 0.3 {W}_{Nb} + 0.15 {W}_{Ta}$$

where, f(γ′) is a numerical value which ranges between 5.6 and 7.0 to produce an alloy with the desired γ′ fraction of between 0.42 and 0.63. If f(γ′) is a numerical value which ranges between 5.6 and 6.5 an alloy with a γ′ fraction between 0.42 and 0.56 is produced resulting in an alloy with an improved combination of high creep strength and AM processing. Described later in reference to improving alloy creep resistance it is preferred to have a γ′ fraction of 0.43 or greater, more preferably 0.45 or greater and most preferably 0.50 or greater, resulting in preferred values of f(γ′) of 5.7 or more, 5.8 or more and 6.0 or more respectively.

The elements platinum, palladium behave in a similar way to that of tantalum, titanium and niobium i.e. they are γ′ forming elements which increase anti-phase boundary energy. These elements can optionally be added to the alloy in substitution for the elements tantalum, titanium and niobium. The benefits of this may include an improvement in resistance to high temperature corrosion. The “aluminium equivalent”, for platinum and palladium require correctional factors (determined from their density relative to aluminium) of 0.125 and 0.225 respectively. However, additions of these elements can be limited due to the high cost of these elemental additions. Therefore, those elements can each be present in an amount of up to 1.0 wt. %, preferably they are limited to 0.5 wt. % or less and most preferably 0.1 wt. % or less as this range provides the best balance of cost and improvement to corrosion resistance. It is preferred that the following equation is satisfied to provide good processing by additive manufacturing

$${W}_{Al} + 0.5 {W}_{Ti} + 0.3 {W}_{Nb} + 0.15 {W}_{Ta} + 0.125 {W}_{Pt} + 0.225 {W}_{Pd} \leq 7.$$

$$preferably$$

$${W}_{Al} + 0.5 {W}_{Ti} + 0.3 {W}_{Nb} + 0.15 {W}_{Ta} + 0.125 {W}_{Pt} + 0.225 {W}_{Pd} \leq 6.5$$

where W_{Pt} and W_{Pd} are the weight percent of platinum and palladium in the alloy respectively.

The propensity for an alloy to form hot cracks is determined in terms of a hot cracking index (Equation 11). This hot cracking mechanism is driven by elements which segregate primarily to the liquid phase during solidification, in the design space studied (Table 2) niobium and tantalum are elements which segregate most heavily to liquid phase, therefore they have the strongest influence on hot cracking.

FIG. 3 shows the hot cracking index as a function of the of elements aluminium, niobium and tantalum as these drive strain age cracking (as described in relation to FIG. 1 balancing of strain age cracking and hot cracking is necessary for best AM processability). It is seen that niobium and tantalum strongly affect the hot cracking index. The alloys listed in Table 1 show a high propensity for hot cracking failure during AM, alloy IN738 is the least prone to hot cracking with an index of 1.8, it has been demonstrated that for example with careful control of zirconium and silicon levels in IN738 hot cracking can be almost eliminated in this alloy and so it is considered an upper bound for compositions which can resist hot cracking (M. Vilanova et al., Influence of Minor Alloying Element Additions on the Crack Susceptibility of a Nickel Based Superalloy Manufactured by LPBF, Materials. 14, (2021), 5702). Alloys which process very well in AM and do not exhibit hot cracking, such as alloy 718 and alloy 625 have a hot cracking index of less than 1.0 (FIG. 1). For an alloy which is much more resistant to hot cracking an index of less than 1.8 which is equivalent to or less that IN738 is useful, from FIG. 3 it is determined that to achieve the desired hot cracking index the niobium and tantalum content must satisfy the following constraint

$$f ( HCI ) = 0.3 {W}_{Nb} + 0.15 {W}_{Ta}$$

where f(HCI) is a numerical value, of which a value of 0.6 or greater achieves a hot cracking index of 1.8 or less. On FIG. 2 the line for a hot cracking index of 1.8 is superimposed. It is seen that to achieve a hot cracking index of 1.8 or less in combination with a strain age cracking index of 7.0 or less aluminium must be limited to 6.0 wt. % or less. More preferably a hot cracking index of 1.8 or less in combination with a strain age index of 6.5 or less is desired so it is preferable to limit to 5.6 wt. % aluminium. In an embodiment aluminium is limited to 5.5 wt. % or less or even to 5.3 wt. % or less to increase strain age cracking resistance further. In an embodiment the alloy contains 5.2% or less aluminium, preferably 5.1% or less aluminium and such an alloy is particularly resistant to hot cracking. In an embodiment aluminium is limited to less than 5.0 wt %, or even 4.95 wt. % or less. A particularly good level of aluminium is 4.85 wt % to 4.85 wt. %, in particular in combination with a level of chromium of greater than 10/0 wt. % or 10.1 wt. % to 10.5 wt. % chromium as this achieves good physical properties as well as good oxidation resistance—see example 1. In an embodiment hot cracking resistance is increased by deliberate additions of niobium and/or tantalum. Suitable minimum preferred amounts of niobium are 0.05 wt. % or more, 0.5 wt. % or more or even 1.0 wt. % or more. Suitable minimum preferred amounts of tantalum are 1.1 wt. % or more, 2.0 wt. % or more or even 2.5 wt. % or more. In an embodiment the alloy has a f(HCI) of 0.625 or greater or even 0.65 or greater with the benefit being increased resistance to hot cracking.

Additions of cobalt have the effect of lowering the γ′ solvus temperature. A lowering of γ′ solvus temperature is desirable as it reduces the temperature at which γ′ precipitation will occur which is advantageous for reducing the rate at which strain-age hardening occurs, as this relies on γ′ precipitation. A lower γ′ solvus also improves the ability to perform solution heat-treatment needed to homogenise distribution of elemental species occurring after the AM process and also needed to modify certain microstructural features, for example enlarging grain size and to dissolve coarse γ′ precipitates which do not provide a great strengthening benefit; by rapidly cooling from solution heat-treatment temperature a fine dispersion of γ′ particles can be achieved which aid improved mechanical properties. Cobalt can be added as an optional element and if so, optionally in substitution for nickel. In an embodiment the alloy may contain, in weight percent 5.5 wt. % or more cobalt, preferably 6.0 wt. % or more cobalt to take advantage it these effects. Preferably a minimum level of cobalt of 7.0 wt. % or more or even 8.0 wt. % or more is used and all example alloys below have at least such a level of cobalt. A more preferred minimum level of cobalt is 9.0 wt. % and an even more preferable limit is 10.0 wt. % or more. In an embodiment cobalt is present in an amount of 8.0 to 9.0 wt. %, (see example 1), resulting in an excellent balance between gamma and freezing range.

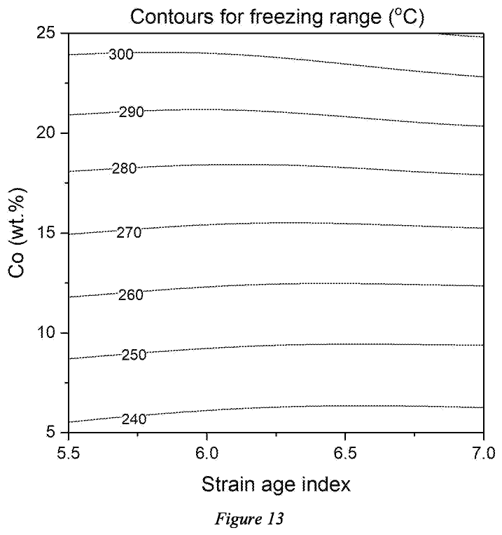

However, as cobalt content increases, the Scheil solidification temperature range of the alloy is increased (FIG. 13). A high freezing range is associated with an increased length of time to solidify, and when the alloy is in a semi-solid condition it can be at risk of solidification cracking, so it is desirable to limit the freezing range. A target freezing range of 300° C. or less is desired, therefore cobalt up to 22.0 wt. % is allowable. In order to match the freezing range of IN792, it is desirable that the cobalt content is 15.0 wt. % or less, more desirable to limit cobalt to 10.0 wt. % or less. In an embodiment in order to reduce the freezing range yet further, cobalt is limited to 9.5 wt. % or less, 9.1 wt. % or less cobalt or even 9.0 wt. % or less.

The relationship between γ′ volume fraction and creep merit index on creep resistance (in terms of temperature capability at 137 MPa, with contours normalised to IN713) is shown in FIG. 4, increasing both parameters will increase creep resistance and the sensitivity to each parameter is determined. The position of the alloys listed in Table 3 are shown in FIG. 4. The aim of the invention is to have a creep performance which is equivalent to IN713C, more preferably an improvement of 25° C. is desired.

For the alloy of this invention it is desired that the creep merit index higher than alloy IN713C. Therefore, for the alloy of this invention a creep merit index of 6.0×10⁻¹⁵ m⁻²s is desired. The elemental additions required to achieve this level of creep merit index are reviewed in following section with reference to FIG. 5. The maximum achievable creep merit index is determined from the need to have a minimum of 6.0 wt. % chromium in the alloy for corrosion resistance while maintaining a stable microstructure which is essentially free from TCP phases (see FIG. 5). A γ′ volume fraction of 0.42 is desired to have a creep resistance equivalent to IN713C. More preferably a minimum of 25° C. improvement of creep resistance of IN713C is desired, therefore particularly when the creep merit index is 6.0×10⁻¹⁵ m⁻²s it is preferable to have a γ′ volume fraction of 0.50, this is equivalent to numerical value of f(γ′) greater than or equal to 6.0.

Slow diffusing elements which partition to the gamma matrix phase most strongly influence the creep merit index, which is calculated based upon the composition of the gamma-phase at an equilibrium temperature of 900° C. Tungsten is the slowest diffusing element in the alloy design space listed in Table 2, followed by molybdenum. The influence of the elements tungsten and molybdenum on creep resistance is presented in FIG. 5. From FIG. 5 it is determined that the change in creep merit index was related to the sum of the elements molybdenum and tungsten according to the formula

$$f ( CMI ) = {W}_{W} + 0.65 {W}_{Mo}$$

where f(CMI) is a numerical value and W_{W} and W_{Mo} are the weight percent of tungsten and molybdenum in the alloy respectively. A value of 4.0 or greater is desired as this achieves the desired creep merit index of 6.0×10⁻¹⁵ m⁻²s. Based upon the maximum limit of molybdenum (3.0 wt. %) a minimum tungsten content of 2.0 wt. % is required. More preferably molybdenum is limited to 2.0 wt. % therefore it is preferred to have a tungsten content of 2.7 wt. % or greater. Most preferably molybdenum is limited to 1.8 wt. % therefore it is most preferable to have a minimum of 2.8 wt. % or greater tungsten. A more desirable level of f(CMI) is 6.0 or greater, preferably 8.0 or greater.

For an even better combination of creep resistance and resistance to strain age cracking it is desired to have a 25° C. improvement in temperature capability over IN713C combined with a strain age cracking index of 6.5 or less. This limits the maximum γ′ volume fraction to 0.56, therefore a creep merit index of 6.90×10⁻¹⁵ m⁻²s or greater is required. To achieve a creep merit index of 6.90×10⁻¹⁵ m⁻²s or greater the value for f(CMI) must be 6.4 or greater. Based upon the maximum limit of molybdenum (3 wt. %) a minimum tungsten content of 4.7 wt. % is required. More preferably molybdenum is limited to 2.0 wt. % therefore it is preferred to have a tungsten content of 5.1 wt. % or greater. Most preferably molybdenum is limited to 1.8 wt. % therefore it is most preferable to have a minimum of 5.2 wt. % or greater tungsten. In an embodiment further optimised for increased creep resistance, tungsten is present in an amount of 6.2 wt. % or more.

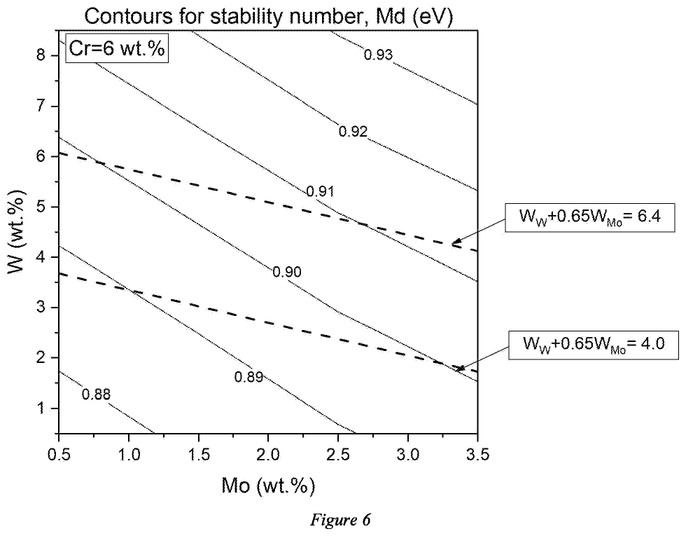

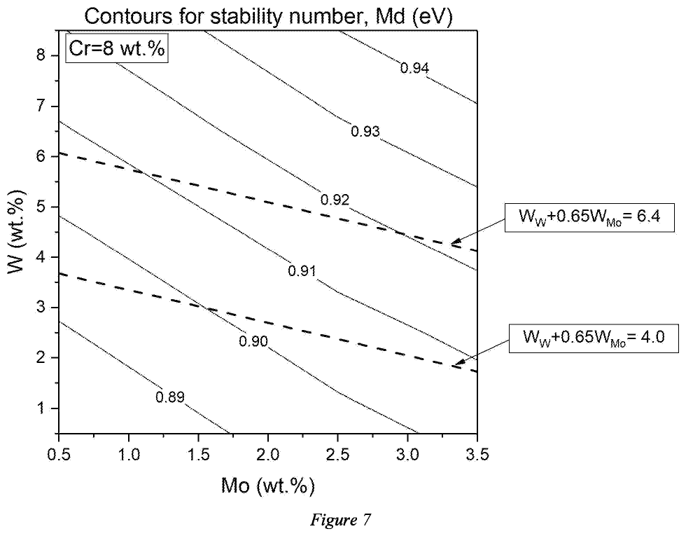

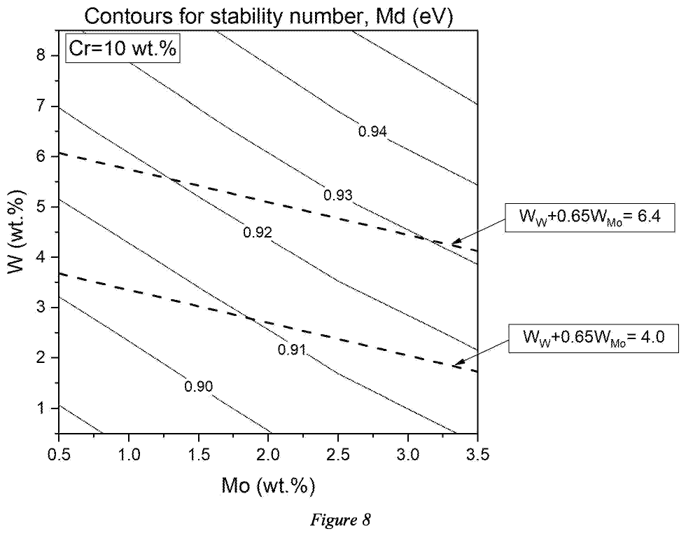

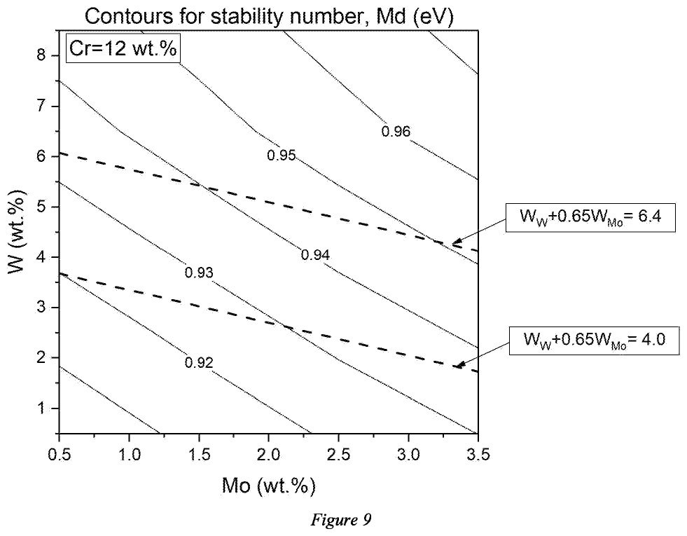

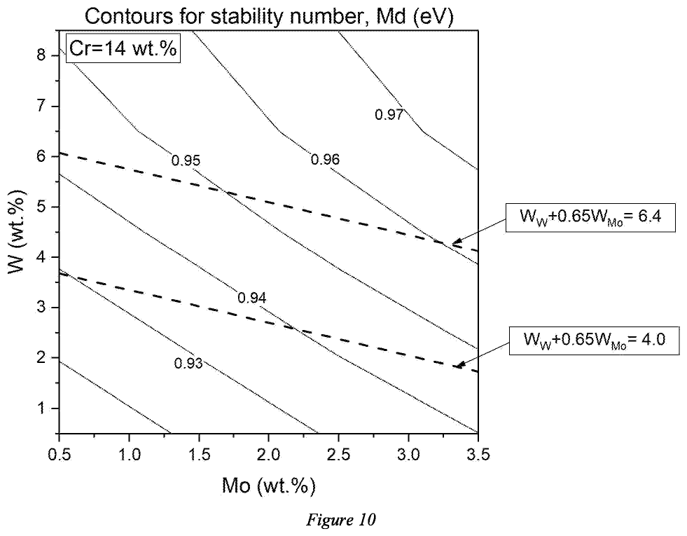

The elements rhenium, ruthenium and iridium behave in a similar way to that of tungsten i.e. they are gamma forming elements which improve the creep merit index. These elements can optionally be added to the alloy. Additions of these elements will significantly increase the creep response of the alloy in comparison to tungsten (as they have much slower diffusivity), however this is achieved with substantial increases in cost due to the high cost of the elements. Preferably the addition of rhenium, ruthenium and iridium is limited to less than 3.0 wt. % each and even more preferably less than 2.0 w % each, most preferably less than 1.5 wt. % each due to their elemental cost. Additions of Rhenium are particularly desirable (for example as a substitute for tungsten) and result in an improved balance of alloy creep resistance and oxidation corrosion resistance whilst maintaining alloy stability. For this reason, levels of rhenium are preferably kept high, for example 2.9% or less rhenium, or 2.5% or less rhenium if reduced cost is an important factor in the alloy design compared to creep resistance and oxidation corrosion resistance. Looking at FIGS. 6-10 it can be seen that if rhenium is used in substitution tungsten a high level of chromium can be achieved, improving oxidation resistance, for a given level of creep merit index, and improving creep, while maintaining a desired level of microstructural stability. Rhenium can substitute for W at a ratio of 0.3% Re for 1% In. In an embodiment of the invention even small Rhenium additions of 0.1 wt. % or more, or 0.2 wt. % or more are preferred, or 0.3 wt. % or more are preferred, more preferably 0.5 wt. % or more and most preferably 0.8 wt. % or more to achieve a desirable combination of creep strength, oxidation/corrosion resistance and microstructural stability.

There is a trade-off between creep resistance (in terms of creep merit index), alloy stability (in terms of Md number) and alloy corrosion resistance (in terms of chromium content). The limit for alloy stability at different levels of chromium content as determined by the equation for f(stability) (described below with reference to FIGS. 6-10) are delineated on FIG. 5. It is seen that as chromium is increased for a given microstructural stability the creep merit index reduces. Thus lower levels of chromium are seen to be beneficial for microstructural stability and for high creep merit index.

Improvements in oxidation and in particular corrosion resistance come from additions of chromium. However, the additions of molybdenum and tungsten for creep resistance as well as chromium for oxidation and corrosion resistance will increase the propensity for the alloy to form unwanted TCP phases. FIGS. 6-10 show the effect of tungsten and molybdenum additions on phase stability for alloys containing different levels of chromium. A higher stability number results in an alloy which is more prone to TCP phase formation. Limiting or stopping the precipitation of TCP phase formation is beneficial as these phases lead to deterioration in material properties over time. A complex trade-off between mechanical performance, oxidation/corrosion resistance and microstructural stability must be managed.

A stability number target (Md) of 0.93 or less (determined at an equilibrium temperature of 900° C.) is desired in order to ensure microstructural stability and avoid TCP formation, see prior art alloys in Table 3. More preferably a stability number target of 0.92 or less is desirable in order to ensure better microstructural stability and avoid TCP formation. From data such as in FIGS. 6-10 it has been determined that for alloys with a volume fraction of γ′ between 42-63%, assuming the minimum amount of tungsten of 2.0 wt. %, chromium may be present in an amount of 16.7 wt. % or less in order to satisfy the desirable microstructural stability Md of 0.93 or less. When chromium levels are 6.0 wt. % a maximum limit of 12.7 wt. % tungsten can be included in the alloy to meet a stability target of 0.93. A preferred chromium content of 8.0 wt. % and even more preferably 10.0 wt. % results in tungsten being limited to 10.7 wt % or less and 8.7 wt. % or less respectively. In an embodiment tungsten is limited to 9.5 wt. % or less tungsten. In other embodiments tungsten is limited to 8.5 wt. % or less tungsten or even 8.0 wt. % or less tungsten, further to reduce density of the alloy and increase microstructural stability. In an embodiment tungsten is limited to 7.6 wt. % or less tungsten (or even 7.5 wt. % or less) where reduction in density and microstructural stability are paramount.

The best balance of creep resistance and corrosion resistance (while maintaining alloy stability) is achieved when tungsten is equal to 4.0 wt. % (based upon f(CMI)). Limiting the maximum chromium content of the alloy to 14.7 wt. % or less is therefore preferred as this allows 4.0 wt. % tungsten and a stability number Md or 0.93 or less. It is preferable to limit the stability number to 0.92. It is therefore preferable to limit chromium content to 13.8 wt. % as this will limit the stability number to 0.92 providing better microstructural stability.

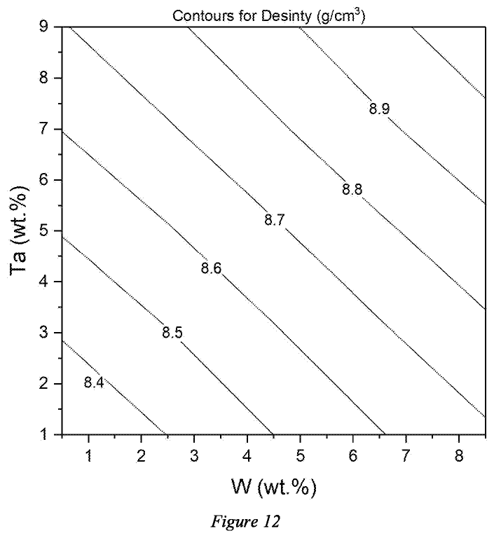

In combination with a high level of mechanical strength—in terms of creep resistance—there is a requirement to limit the density of the alloy. A density target of 8.9 g/cm³ is imposed, this is typical of the upper limit of density for commercially used nickel-based superalloys. From the elements within the alloy design space listed in Table 2 the elements tungsten and tantalum have a density which is significantly greater than nickel and have strongest influence on increasing density. FIG. 12 shows the effect of elements tantalum and tungsten on alloy density. From FIG. 12 it is determined that additions of tungsten and tantalum should adhere to the following equation

$$f ( density ) = {W}_{W} + {W}_{Ta}$$

where f(density) is a numerical value which must be less than 13.9 in order to achieve an alloy with a density of less than 8.9 g/cm³. Given that the minimal required concentration of tungsten (2.0 wt. %) it is necessary to limit the tantalum concentration to less than 11.9 wt. %. Preferably density is limited to less than 8.8 g/cm³, to achieve this the numerical value for f(density) should be less than 11.8 therefore tantalum should be 9.8 wt. % or less. Even more preferably tungsten should be greater than 4.7 wt. % or greater, therefore tantalum should be limited to 9.2 wt. % and 7.1 wt. % to achieve a value of f(density) of 13.9 and 11.8 respectively. A lower level of tantalum (say 7.1 wt. % or less, which is even more desired maximum level for tantalum and which all example alloys below fall within) also allows an optional increased level of tungsten whilst keeping the density of the alloy down. Reductions in density can be achieved by limiting tantalum to 5.5 wt. % or less or even 5.0 wt. % or less. In an embodiment tantalum is allowed up to only 4.5 wt. % or less yet further to reduce density for those applications where low density is crucial. Most preferably tantalum is limited to 4.0 wt. % or less for an even lower density alloy.

Additions of carbon, boron and zirconium provide strength to grain boundaries. This is particularly beneficial for the creep and fatigue properties of the alloy. The carbon concentrations should range from 0.02 wt. % to 0.35 wt. % (e.g., 0.02, 0.03, 0.04, 0.05, 0.06, 0.07, 0.08, 0.09, 0.1, 0.2, 0.3, or 0.35 wt. %, or any range or number therein). Preferably lower levels of carbon are preferred in order to reduce cracking during the additive manufacturing process, thus a content of less than 0.2 wt. % or less than 0.15 wt. % is preferred, more preferably less than 0.1 wt. %. In an embodiment the level of carbon is greater than 0.05 wt. %, for example 0.06 wt. % or more (or even 0.07 wt. % or more) to strengthen grain boundaries. This is a much higher level of carbon than has previously been used, for example in alloys for use as single crystals (which don't have any grain boundaries which need strengthening), where the presence of carbon is detrimental due to providing nucleation sites (which would harm the ability of the alloy to be formed into a single crystal article) and/or reducing the oxidation performance due to the formation of large, scriptic morphology carbides. The boron concentration should range from 0.001 to 0.2 wt. %, preferably less than 0.03 wt. % as boron separates to the liquid phase during solidification and may lead to liquation cracking during the AM process, more preferably less than 0.02 wt. %. In an embodiment zirconium is present in an amount of 0.001 wt. % or more to increase strength at grain boundaries. In an embodiment zirconium is present in an amount of at least 0.002 wt. %, for example 0.002 wt. % to 0.004 wt. % to achieve a balance between increased grain boundary strength.

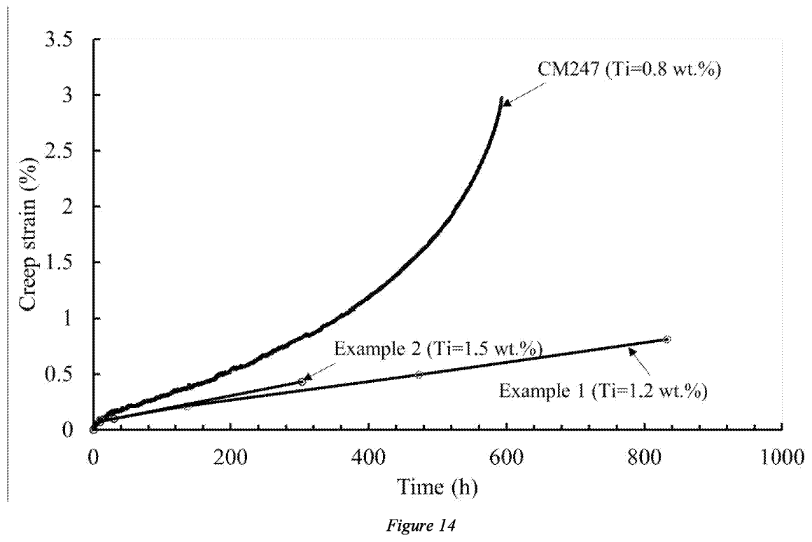

For alloys developed for AM it is particularly advantageous to have strong grain boundaries as the grains are smaller than traditional cast alloys. A dispersion of MC type carbides are advantageous to inhibit grain boundary sliding at temperature above temperature greater than 800° C. Titanium and hafnium are particularly attractive elements for providing grain boundary strengthening in additively manufactured superalloys as these elements are strong carbide formers. Titanium is a particularly beneficial as a carbide formed as the reaction kinetics for titanium carbide are high and so it forms readily during the additive manufacturing process. The alloy has additions of 1.1 wt. % or more as titanium forms very stable MC carbides. As well as adding increased creep resistance it has been shown that titanium carbide particles may act as a nucleating agent during additive manufacture, this nucleating effect can promote more heterogenous nucleation and reduce susceptibility to hot cracking further (H. Quanquan, Additive manufacturing of high-strength crack-free Ni-based Hastelloy X superalloy, 30 (2019), 1009). The improved creep resistance is shown experimentally in FIG. 14 described below.

It is particularly advantageous when titanium carbides include hafnium to become (Ti,Hf)C type MC carbides as hafnium further stabilises the carbide. Additions of hafnium (Hf) of up to 2.0 wt. % are desirable, however hafnium is an expensive element and it also can make the manufacturing of alloy powder more complex due to its high reactivity therefore it is preferably limited to 1.5 wt. %, or more preferably up to 1.2 wt. %, more even more preferably 1.1 wt. %. In addition, hafnium is beneficial for improving oxidation resistance by increasing the adhesion of protective Al₂O₃ oxide layers. Therefore a minimum amount of hafnium of 0.1 wt. % or more is desirable, and a minimum amount of hafnium of 0.2 wt. %, or a minimum amount of hafnium of 0.25 wt. % or 0.3 wt. % or more hafnium or even more preferable 0.5 wt. % from the point of view of increased creep strength and oxidation resistance at the expense of increased cost. The best creep strength and oxidation resistance is achieved at levels of hafnium of 0.6 wt. % or more and this is most preferred, though in one embodiment optimised for increased creep strength and oxidation resistance a minimum of hafnium of 0.8 wt. % is present, leading to an expensive, yet high performing alloy. In an embodiment hafnium is present in an amount on 0.8 to 1.2 wt. %, achieving high mechanical properties and oxidation resistance.

For boron additions it is advantageous to have an increased level of chromium, high level of chromium promote the formation of Cr₅B₃ type borides which are very stable at elevated temperature and have the effect of strengthening grain boundaries and improving creep resistance. Therefore it is preferable to have at least 8.0 wt. % (or 8.5 wt. %) chromium in the alloy and even more preferably at least 9.0 wt. % chromium in the alloy to achieve the best balance of printability and creep resistance. A boron concentration of 0.005 wt. % or more is preferable as this contributes to increased grain boundary strength and improved ductility. These effects are even more prevalent at concentrations of 0.006 wt. % or more of boron and so this is preferred. If boron is present at a level of 0.010 wt. % or more, these effects are even more apparent and so this level of boron is preferred. It is preferred that boron content is between 0.008 wt. % and 0.018 wt. %, even more preferably between 0.008 wt. % and 0.015 wt. % to achieve a desirable balance between AM processibility and creep resistance. In an embodiment boron is present at a level of 0.012 wt. % or less.

The zirconium concentrations should be limited to less than 0.01 wt. % preferably less than 0.005 wt. % and more preferable less than 0.002 wt. % and most preferably less than 0.0015 wt. %. These limitations on zirconium content will result in lower levels of hot cracking (M. Vilanova et al., Influence of Minor Alloying Element Additions on the Crack Susceptibility of a Nickel Based Superalloy Manufactured by LPBF, Materials. 14, (2021), 5702).

It is beneficial that when the alloy is produced, it is substantially free from incidental impurities. These impurities may include the elements sulphur (S), manganese (Mn) and copper (Cu). The element sulphur should remain 0.003 wt. % or less (30 PPM in terms of mass). The presence of sulphur above 0.003 wt. %, can lead to embrittlement of the alloy and sulphur also segregates to alloy/oxide interfaces formed during oxidation, preferably sulphur levels are 0.001 wt. % or less. Manganese is an incidental impurity which is limited to 0.25 wt. %, preferably this limited to 0.1 wt. % or less. Copper is an incidental impurity which is preferably limited to 0.5 wt. %. Vanadium (V) is an incidental impurity, which negatively influences the oxidation behaviour of the alloy and is which is preferably limited to 0.5 wt. %, preferably 0.3 wt. % or less and most preferably this limited to 0.1 wt. % or less. This segregation may lead to increased spallation of protective oxide scales. If the concentrations of these incidental impurities exceed the specified levels, issues surrounding product yield and deterioration of the material properties of the alloy is expected.

Iron behaves in a similar way to nickel and can be added as a low-cost alternative to nickel. Moreover, tolerance to iron additions improves the ability of the alloy to be manufactured from recycled materials. Therefore, it is preferred that iron is present in an amount of at least 0.1 wt. %. However, additions of iron up to 4.0 wt. % can be made in order to substantially reduce the cost. Preferably the additions of iron are 2.0 wt. % or less in order to reduce the propensity to form the unwanted Laves phase which degrades the mechanical properties of the alloy. Most preferably iron additions are limited to 1.0 wt. % as this produces an alloy which has good ability to be recycled with no loss in material performance.

Additions of the so called ‘reactive-elements’, yttrium (Y), lanthanum (La) and cerium (Ce) may be beneficial up to levels of 0.1 wt. % to improve the adhesion of protective oxide layers, such as Al₂O₃. These reactive elements can ‘mop up’ tramp elements, for example sulphur, which segregates to the alloy oxide interface weakening the bond between oxide and substrate leading to oxide spallation. Magnesium (Mg) likewise may act to ‘mop up’ tramp elements, and can have beneficial effects on mechanical properties, so may be added up to 0.1%. Additions of silicon (Si) up to 0.5 wt. % may be beneficial, it has been shown that additions of silicon to nickel based superalloys at levels up to 0.5 wt. % are beneficial for oxidation properties In particular silicon segregates to the alloy/oxide interface and improves cohesion of the oxide to the substrate. This reduces spallation of the oxide, hence, improving oxidation resistance. However silicon may reduce AM processibility of the material therefore it is advantageous to limit it to less than 0.2 wt. %, more preferably 0.1 wt. % and even more preferably less than 0.05 wt. % (M. Vilanova et al., Influence of Minor Alloying Element Additions on the Crack Susceptibility of a Nickel Based Superalloy Manufactured by LPBF, Materials. 14, (2021), 5702).

The alloy of the present invention is designed for good additive manufacturability. Thus the alloy is suitable for being made into a powder suitable for additive manufacturing as this is the form required of the alloy in order to be of use in additive manufacturing (for example LPBF or Directed Energy Deposition (DED)). In such an embodiment, a volume mean particle diameter of the powder is 10 to 200 μm (preferably as measured by laser diffraction under ASTM B822 (for smaller particles and/or sieving under ASTM B214 for larger particles). The alloy can be formed into an additively manufactured article by know additive manufacturing techniques such as powder bed fusion. An additively manufactured article has a grain structure (i.e. is not single crystal, namely is a polycrystal) and as such attention needs to be paid to grain boundary morphology during alloy design to ensure that the grain boundaries are not a physical weakness of the alloy or prone to attack by oxidation, for example. Thus, alloys designed for single crystal applications are unlikely to be suitable for use as a powder for additive manufacturing. In particular, certain elements are added in the present invention to strengthen grain boundaries, most importantly carbon, in order to strengthen grain boundaries and to a lesser extent (and not in all embodiments), zirconium to increase grain boundary strength and boron. Suitable volume mean particle diameters for different types of additive manufacturing processes (for which the alloy is suitable) are:
Laser Powder Bed Fusion: 10-60 μm
Electron Beam Powder Bed Fusion: 60-105 μm
Directed Energy Deposition: 45-150 μm
   The following D10, D50 and D90 results are typical for a powder with a volume mean diameter of 35.8 μm

| D10 | | D50 | | D90 | |
|---|---|---|---|---|---|
| Min | Max | Min | Max | Min | Max |

| | | | |
|---|---|---|---|
| Results μm | 19.7 | 33.4 | 55.6 |

For laser powder bed fusion, D10 may range from 5 to 35 μm, D50 may range from 10 to 60 m and D90 may range from 45-80 μm. For electron beam powder bed fusion D10 may range from 50 to 100 μm, D50 may range from 60 to 105 μm and D90 may range from 80-125 μm. For directed energy deposition D10 may range from 20 to 60 μm, D50 may range from 20 to 150 μm and D90 may range from 100-200 μm.

Based upon the description of the invention presented in this section the broad range for the invention is listed in Table 4. A preferable range is also given in Table 4 as well as a most preferable range.

TABLE 4
Compositional range in wt. % for the newly designed alloy.

| Alloy (wt. %) | Al | Co | Cr | Mo | Nb | Ta | Ti | W | Re | Hf | C | Zr |
|---|---|---|---|---|---|---|---|---|---|---|---|---|
| Min | 4.0 | 0.0 | 6.0 | 0.0 | 0.0 | 0.0 | 1.1 | 2.0 | 0.0 | 0.0 | 0.02 | 0.00 |
| Max | 6.0 | 22.0 | 16.7 | 3.0 | 4.0 | 11.9 | 6.0 | 12.7 | 3.0 | 2.0 | 0.35 | 0.01 |
| Preferable Min | 4.0 | 8.0 | 8.0 | 0.2 | 0.0 | 1.1 | 1.2 | 4.7 | 0.2 | 0.2 | 0.05 | 0.00 |
| Preferable Max | 5.6 | 15.0 | 15.0 | 2.0 | 3.0 | 9.8 | 5.0 | 10.7 | 2.0 | 1.5 | 0.35 | 0.01 |
| More Preferable Min | 4.5 | 8.0 | 9.5 | 0.5 | 0.5 | 2.0 | 1.2 | 5.2 | 0.2 | 0.5 | 0.06 | 0.002 |
| More Preferable Max | 5.3 | 10.0 | 13.8 | 1.8 | 2.0 | 6.3 | 2.5 | 8.7 | 1.5 | 1.2 | 0.35 | 0.005 |
| Most Preferable Min | 4.6 | 8.0 | 9.6 | 0.5 | 0.5 | 2.5 | 1.1 | 6.2 | 0.2 | 0.8 | 0.06 | 0.002 |
| Most preferable Max | 5.0 | 9.1 | 10.5 | 1.8 | 2.0 | 4.0 | 1.35 | 7.6 | 1.5 | 1.2 | 0.35 | 0.004 |

### Examples of the Invention

TABLE 5
Nominal compositions in wt. % of the newly designed high volume fraction
of γ′ nickel-based superalloys compared with the alloys listed in Table 1.

| Alloy | | | | | | | | | | | | | | | |
|---|---|---|---|---|---|---|---|---|---|---|---|---|---|---|---|
| (wt. %) | Al | Co | Cr | Mo | Nb | Ta | Ti | W | Re | C | B | Zr | Hf | f(HCI) | f(CMI) |
| IN738 | 3.4 | 8.5 | 16.0 | 1.8 | 0.9 | 1.8 | 3.4 | 2.6 | 0.0 | 0.11 | 0.01 | 0.04 | 0.0 | 0.53 | 3.7 |
| CM247 | 5.5 | 9.5 | 8.4 | 0.5 | 0.0 | 3.0 | 0.7 | 9.5 | 0.0 | 0.07 | 0.015 | 0.015 | 1.5 | 0.45 | 9.8 |
| IN713 | 6.0 | 0.0 | 12.5 | 4.5 | 2.0 | 0.0 | 0.8 | 0.0 | 0.0 | 0.12 | 0.001 | 0.10 | 0.0 | 0.60 | 2.9 |
| IN792 | 3.2 | 9.0 | 12.7 | 1.8 | 0.0 | 3.9 | 4.2 | 3.9 | 0.0 | 0.07 | 0.016 | 0.018 | 0.0 | 0.59 | 5.1 |
| Example 1 | 4.9 | 8.6 | 10.2 | 0.9 | 0.7 | 3.0 | 1.2 | 7.1 | 0.3 | 0.07 | 0.013 | 0.003 | 1.0 | 0.66 | 7.7 |
| Example 2 | 4.5 | 8.7 | 11.3 | 1.3 | 1.4 | 3.1 | 1.6 | 5.2 | 0.87 | 0.07 | 0.009 | 0.003 | 0.58 | 0.86 | 6.0 |

TABLE 6
Calculated phase fractions and merit indices made with the “Alloys-by-Design”
software. Results for conventional high volume fraction of γ′ nickel-
based superalloys used listed in Table 1 and newly designed high volume fraction
of γ′ nickel-based superalloys compared with the alloys listed in Table 1.

| | | Creep | | Strength | | | | | |
|---|---|---|---|---|---|---|---|---|---|
| | | Merit | | Merit | | Strain | Hot | Freezing | |
| | | Index | Density | Index | Md | Age | Cracking | Range | Cost |
| Alloy | γ′ | (m⁻²s × 10⁻¹⁵) | (g/cm³) | (MPa) | (eV) | Index | Index | (° C.) | $/kg |
| IN738 | 0.45 | 5.9 | 8.3 | 1517 | 0.92 | 5.6 | 1.82 | 259 | 5.5 |
| CM247LC | 0.59 | 8.0 | 8.6 | 1243 | 0.92 | 6.3 | 4.44 | 606 | 10.6 |
| IN713 | 0.55 | 5.8 | 8.0 | 1139 | 0.93 | 7.0 | 2.03 | 213 | 2.5 |
| IN792 | 0.51 | 6.4 | 8.5 | 1702 | 0.92 | 5.9 | 2.05 | 269 | 7.4 |
| Example 1 | 0.55 | 8.9 | 8.5 | 1582 | 0.92 | 6.1 | 1.55 | 288 | 15.4 |
| Example 2 | 0.54 | 8.5 | 8.5 | 1675 | 0.93 | 6.1 | 1.75 | 290 | 23.1 |

Examples of the alloy invention, Example 1 and Example 2, are show in Table 5 and Table 6. The alloys have a high creep resistance, achieved from a high γ′ volume fraction and a high creep merit index. As described later in this Section, with reference to measured creep results for the example alloys, the alloys have a titanium content of greater than 1.1 wt. % to increase grain boundary strengthening and achieve a high level of creep resistance. This high level of creep resistance is achieved in combination with good oxidation and a high level of AM processibility. The good oxidation resistance of examples 1 and 2 is achieved by using a high aluminium content (>4.5 wt. %) to achieve formation of a protective alumina scale at 1000° C. The low strain age cracking index and a lower hot cracking index allows for superior printability over CM247.

FIG. 14 compares the creep results for AM processed CM247 and the example alloys listed in Table 5 (examples 1 and 2 are not tested to failure, whereas CM247 was tested to failure). From FIG. 4 it is seen that the combination of γ′ volume fraction and creep merit index for the example alloys was predicted to result in the equivalent creep resistance. The results show that the examples of this invention have a lower rate of creep than CM247 at the creep conditions of 900° C./200 MPa. This high level of creep resistance has been determined to be the result of an added grain boundary strengthening effect of stable titanium MC carbide formation resulting in stronger grain boundaries which reduce the rate of creep in these new alloys compared to CM247. Example 1 and Example 2 have titanium contents of 1.2 wt. % and 1.5 wt. % respectively compared to the titanium of 0.8 wt. % in CM247. It is expected that the beneficial effect will extend at least down to 1.1 wt. % titanium and will still be observable at higher levels up to at least 6.0 wt. %.

1. A nickel-based alloy composition consisting, in weight percent, of: 4.0 to 6.0% aluminium, 1.1 to 6.0% titanium, 0.0 to 4.0% niobium, 0.0 to 11.9% tantalum, 2.0 to 12.7% tungsten, 0.0 to 3.0% molybdenum, 0.0 to 22.0% cobalt, 6.0 to 16.7% chromium, 0.02 to 0.35% carbon, 0.001 to 0.2% boron, 0.00 to 0.01% zirconium, 0.0 to 3.0% rhenium, 0.0 to 3.0% ruthenium, 0.0 to 3.0% iridium, 0.0 to 0.5% vanadium, 0.0 to 1.0% palladium, 0.0 to 1.0% platinum, 0.0 to 0.5% silicon, 0.0 to 0.1% yttrium, 0.0 to 0.1% lanthanum, 0.0 to 0.1% cerium, 0.0 to 0.003% sulphur, 0.0 to 0.25% manganese, 0.0 to 0.1 magnesium, 0.0 to 4.0% iron, 0.0 to 0.5% copper, 0.0 to 2.0% hafnium, the balance being nickel and incidental impurities.

2. The nickel-based alloy composition according to claim 1, wherein the following equation is satisfied in which W_{Nb} and W_{Ta} are the weight percent of niobium and tantalum in the alloy respectively
$$0.6 \leq 0.3 {W}_{Nb} + 0.15 {W}_{Ta} .$$

3. The nickel-based alloy composition according to claim 1, wherein the following equation is satisfied in which W_{Al}, W_{Ti} W_{Nb} and W_{Ta} are the weight percent of aluminium, titanium, niobium and tantalum in the alloy respectively
$$5.6 \leq {W}_{Al} + 0.5 {W}_{Ti} + 0.3 {W}_{Nb} + 0.15 {W}_{Ta} \leq 7. .$$

4. (canceled)

5. (canceled)

6. The nickel-based alloy composition according to claim 1, wherein the following equation is satisfied in which W_{W} and W_{Mo} are the weight percent of tungsten and molybdenum in the alloy respectively
$${W}_{W} + 0.65 {W}_{Mo} \geq 4. .$$

7. The nickel-based alloy composition of claim 1, consisting of, in weight percent, 8.0% or more chromium.

8. (canceled)

9. The nickel-based alloy composition of claim 1 consisting of, in weight percent, 9.8 wt. % or less tantalum.

10. The nickel-based alloy composition of claim 1 consisting of, in weight percent, 2.0% or less molybdenum.

11. The nickel-based alloy composition of claim 1 consisting of, in weight percent, 3.0% or less titanium.

12. (canceled)

13. The nickel-based alloy composition of claim 1 consisting of, in weight percent, 10.7% or less tungsten.

14. (canceled)

15. (canceled)

16. The nickel-based alloy composition of claim 1, consisting, in weight percent, 4.3% or more aluminium.

17-22. (canceled)

23. The nickel-based alloy composition of claim 1, wherein the following equation is satisfied in which W_{Ta} and W_{W} are the weight percent of tantalum and tungsten in the alloy respectively
$${W}_{W} + {W}_{Ta} \leq 13.9 .$$

24. (canceled)

25. The nickel-based alloy composition of claim 1 consisting of, in weight percent, of 0.5 wt. % or more hafnium.

26. The nickel-based alloy composition according to claim 1, consisting of, in weight percent 5.5% or more cobalt.

27. The nickel-based alloy composition according to claim 1, consisting of, in weight percent 0.05 wt. % or more niobium.

28. (canceled)

29. The nickel-based alloy composition according to claim 1, consisting of, in weight percent 7.1 wt. % or less tantalum.

30-34. (canceled)

35. The nickel-based alloy composition according to claim 1, consisting of, in weight percent, 0.1% or more rhenium.

36. The nickel-based alloy composition according to claim 1, consisting of, in weight percent, less than 0.1% silicon.

37. The nickel-based alloy composition according to claim 1, comprising at least 0.06 wt. % carbon.

38. The nickel-based alloy composition according to claim 1, consisting of the Table 5, Example 1, alloy composition.

39. (canceled)

40. (canceled)

41. A powder suitable for additive manufacturing, wherein the powder is a powder of the nickel-based alloy of claim 1.

42. (canceled)

43. (canceled)
